(19) United States
(12) Patent Application Publication
(10) Pub. No.: US 2025/0267610 A1
(43) Pub. Date: Aug. 21, 2025

(54) TRAFFIC SWITCHING, STEERING AND SPLITTING USING TWO WIRELESS SUBSCRIPTIONS

(71) Applicant: Charter Communications Operating, LLC, St. Louis, MO (US)

(72) Inventors: Yildirim Sahin, Englewood, CO (US); Paul L. Russell, JR., Lawrence, NJ (US)

(21) Appl. No.: 19/055,354

(22) Filed: Feb. 17, 2025

Related U.S. Application Data
(60) Provisional application No. 63/554,355, filed on Feb. 16, 2024.
(60) Provisional application No. 63/639,408, filed on Apr. 26, 2024.
(60) Provisional application No. 63/649,020, filed on May 17, 2024.

(51) Int. Cl. H04W 60/04; H04W 8/22; H04W 76/16; H04W 84/04

(52) U.S. Cl. CPC H04W 60/04; H04W 8/22; H04W 76/16; H04W 84/042

(57) ABSTRACT

A wireless user equipment (UE) sends, to a first wireless network, a first registration request, the first registration request including a request to connect to the first wireless network and a first subscription identifier (ID) identifying a first wireless subscription and a dualsteer indication that the UE is capable of supporting a dualsteer (DS) mode utilizing two different wireless subscriptions, the first wireless subscription being one of the two different wireless subscriptions. The UE receives, from the first wireless network, a first registration accept message indicating network support for the DS mode.

### RELATED APPLICATIONS

This application claims the benefit of U.S. Provisional Patent Application No. 63/554,355, filed on Feb. 16, 2024, entitled “TRAFFIC SWITCHING, STEERING AND SPLITTING OVER TWO 3GPP ACCESSES,” U.S. Provisional Patent Application No. 63/639,408, filed on Apr. 26, 2024, entitled “TRAFFIC SWITCHING, STEERING AND SPLITTING OVER TWO 3GPP ACCESSES,” and U.S. Provisional Patent Application No. 63/649,020, filed on May 17, 2024, entitled “TRAFFIC SWITCHING, STEERING AND SPLITTING OVER TWO 3GPP ACCESSES,” the disclosures of each of which are hereby incorporated herein by reference in their entireties.

### BACKGROUND

To access a wireless network a user equipment (UE) is associated with a wireless subscription of a wireless operator.

### SUMMARY

In one example a method is provided. The method includes sending, by a wireless user equipment (UE), to a first wireless network, a first registration request, the first registration request comprising a request to connect to the first wireless network and a first subscription identifier (ID) identifying a first wireless subscription and a dualsteer indication that the UE is capable of supporting a dualsteer (DS) mode utilizing two different wireless subscriptions, the first wireless subscription being one of the two different wireless subscriptions. The method further includes receiving, by the UE from the first wireless network, a first registration accept message indicating network support for the DS mode.

In another example a wireless user equipment (UE) is provided. The UE includes a memory, and a processor device coupled to the memory and operable to send, to a first wireless network, a first registration request, the first registration request comprising a request to connect to the first wireless network and a first subscription identifier (ID) identifying a first wireless subscription and a dualsteer indication that the UE is capable of supporting a dualsteer (DS) mode utilizing two different wireless subscriptions, the first wireless subscription being one of the two different wireless subscriptions. The processor device is further operable to receive, from the first wireless network, a first registration accept message indicating network support for the DS mode.

In another example a non-transitory computer-readable storage medium is provided. The non-transitory computer-readable storage medium includes includes executable instructions operable to cause one or more processor devices of a wireless user equipment (UE) to send, to a first wireless network, a first registration request, the first registration request comprising a request to connect to the first wireless network and a first subscription identifier (ID) identifying a first wireless subscription and a dualsteer indication that the UE is capable of supporting a dualsteer (DS) mode utilizing two different wireless subscriptions, the first wireless subscription being one of the two different wireless subscriptions. The instructions are further operable to cause the one or more processor devices to receive, from the first wireless network, a first registration accept message indicating network support for the DS mode.

In another example a method is provided. The method includes receiving, by a mobility node of a wireless network, a registration request from a user equipment (UE), the registration request comprising a request to connect to a wireless network and comprising a dualsteer indication that the UE is capable of supporting a dualsteer (DS) mode utilizing two different wireless subscriptions. The method further includes selecting, by the mobility node based at least in part on the dualsteer indication, a policy node from a plurality of policy nodes, the policy node being operable to support the DS mode. In another example a method is provided. The method further includes sending, by the mobility node to the UE, a registration accept message indicating network support for the DS mode.

In another example a method is provided. The method includes receiving, by a data session handler node of a wireless network from a mobility node of the wireless network, a request to establish a subscription data session for a user equipment (UE) having a first wireless subscription and a second wireless subscription, the request comprising a dualsteer indication that the UE is capable of supporting a DS mode utilizing the first wireless subscription and the second wireless subscription and wherein the request is associated with the first wireless subscription. The method further includes providing, by the data session handler node to a policy node, information that identifies the UE and information that indicates the UE is capable of supporting the DS mode. The method further includes receiving, by the data session handler node from the policy node, DS rules comprising traffic steering rules. The method further includes selecting, by the data session handler node, a data traffic handling node of a plurality of data traffic handling nodes to interface with the UE to forward traffic from the UE to an external network. The method further includes providing, by the data session handler node to the mobility node for delivery to the UE, a data traffic handling node identifier identifying the data traffic handling node and the DS rules comprising the traffic steering rules.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which traffic switching, steering and splitting using two wireless subscriptions can be implemented;

FIG. 2 is flowchart of a method, from a perspective of a user equipment (UE), to implement traffic switching, steering and splitting using two wireless subscriptions according to one implementation;

FIG. 3 is a block diagram of a non-roaming 5G system architecture;

FIG. 4 is a block diagram of a roaming 5G system architecture;

FIG. 5 is a block diagram illustrating aspects of a UE capable of implementing dualsteer functionality according to one implementation;

FIG. 6 is a message sequence diagram illustrating a registration by a UE to a HPLMN wireless network using subscription A according to one implementation;

FIG. 7 is a message sequence diagram illustrating a registration by the UE to a HPLMN wireless network using subscription B according to one implementation;

FIG. 8 is a message sequence diagram illustrating an alternate example to FIG. 7 wherein the UE registers to a VPLMN wireless network using subscription B according to one implementation;

FIGS. 9A-9B illustrate a modified Structure Description suitable for supporting the DS mode disclosed herein according to one implementation;

FIG. 10 illustrates alternative #1 and alternative #2, respectively, for sample URSP rules for SUPI_A and SUPI_B for traffic descriptors of X and Y according to one implementation;

FIGS. 11A-11B are a message sequence diagram illustrating a Multi-Access (MA) PDU session establishment by a UE with PLMN1 using SUPI_A (i.e., subscription A) identifying the Linked SUPI_B according to one implementation;

FIGS. 12A-12B are a message sequence diagram illustrating a Multi-Access (MA) PDU session establishment by the UE with PLMN2 using SUPI_B (i.e., subscription B), identifying the Linked SUPI_A according to one implementation;

FIGS. 13A-13B are a message sequence diagram illustrating a Multi-Access (MA) PDU session establishment by the UE with PLMN2 using SUPI_B (i.e., subscription B) identifying the Linked SUPI_A according to one implementation;

FIGS. 14A-14B are a message sequence diagram illustrating a regular PDU session establishment by the UE with PLMN1 using SUPI_A (i.e., subscription A), identifying the Linked SUPI_B according to one implementation;

FIGS. 15A-15B are a message sequence diagram illustrating a PDU session establishment by the UE with PLMN2 using SUPI_B (i.e., subscription B), identifying the Linked SUPI_A according to one implementation;

FIGS. 16A-16B are a message sequence diagram illustrating PDU session establishment by the UE with PLMN1 using SUPI_A (i.e., subscription A), wherein the Linked SUPI_B is not identified in the UL NAS Transport/PDU Session Establishment Request message according to one implementation;

FIGS. 17A-17B are a message sequence diagram illustrating a Multi-Access (MA) PDU session establishment by the UE with PLMN2 using SUPI_B (i.e., subscription B) wherein Linked SUPI_A is not identified in the UL NAS Transport/PDU Session Establishment Request message according to one implementation;

FIG. 18 is a block diagram of a sample DS connectivity model wherein SUPI_A is used to connect to PLMN1 as the HPLMN of the UE and SUPI_B is used to connect to PLMN2 as a VPLMN;

FIG. 19 is a block diagram of a sample DS connectivity model wherein SUPI_A is used to connect to PLMN1 as the HPLMN of the UE and SUPI_B is used to connect to PLMN2 as the HPLMN;

FIG. 20 is a block diagram of a sample DS connectivity model wherein SUPI_A is used to connect to PLMN1 as a VPLMN of the UE and SUPI_B is used to connect to PLMN2 as a VPLMN;

FIG. 21 is a block diagram of a computing device 2100 suitable for implementing any of the various nodes discussed herein, such as, for example, an AMF node, an SMF node, a PCF node, a UPF node, or a UDM node; and

FIG. 22 is a block diagram of a user equipment (UE) suitable for implementing the examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

To access a wireless network a user equipment (UE) is associated with a wireless subscription of a wireless operator. Conventionally a UE can roam from one public land mobile network (PLMN) to another PLMN relatively seamlessly, even where such PLMNs are operated by different operators, using a single wireless subscription. Communications between a UE and various elements of a PLMN that facilitate connection (e.g., registration), data session establishment, roaming and the like are described, for example, in 3GPP TS 23.502 (e.g., V19.0.0) “3rd Generation Partnership Project; Technical Specification Group Services and System Aspects; Procedures for the 5G System (5GS); Stage 2 (Release 19)”, the contents of which are incorporated herein by reference in their entirety.

It may be desirable for a UE to be associated with more than one wireless subscription to, for example, allow the UE to establish multiple, concurrent data sessions through a same PLMN or two PLMNs. The examples disclosed herein implement traffic switching, steering and splitting using two wireless subscriptions. The examples have applicability to UE and wireless networks, including, by way of non-limiting example, wireless networks that are compliant with 3GPP specifications.

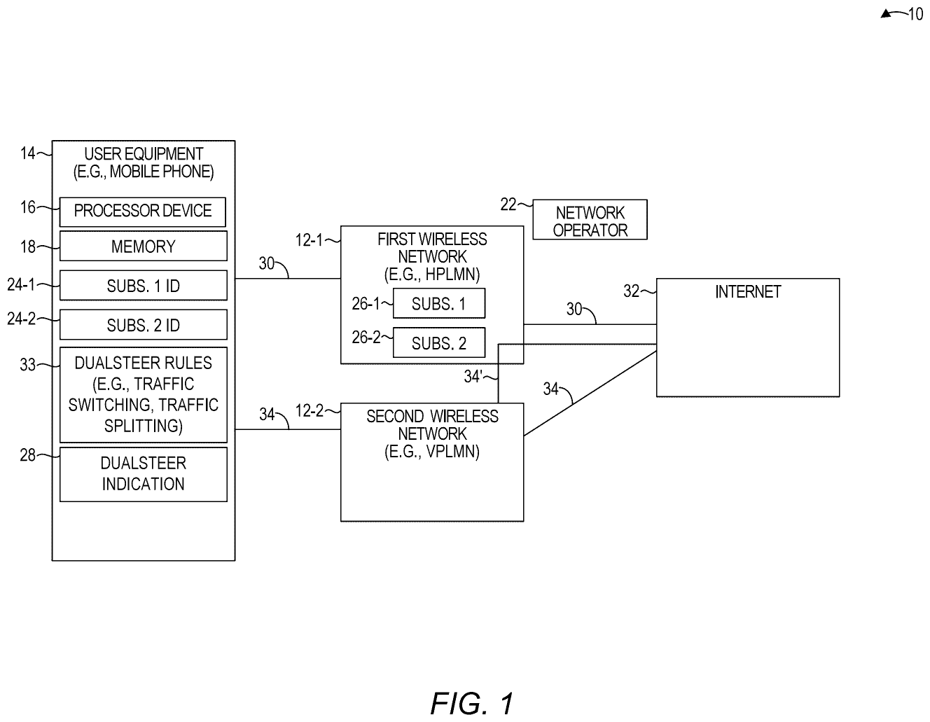

FIG. 1 is a block diagram of an environment 10 in which traffic switching, steering and splitting using two wireless subscriptions can be implemented. The environment 10 includes a first wireless network 12-1 and a second wireless network 12-2 (generally, wireless networks 12). The wireless networks 12 may, for example, be operated by the same operator or by different operators. The wireless networks 12 may utilize the same technologies, such as 5G technology, or different technologies, such as the wireless network 12-1 may utilize 5G technology and the wireless network 12-2 may utilize 4G technology. The wireless networks 12 communicate with one another as needed to coordinate management of a UE 14. Solely for purposes of illustration it will be assumed that the two wireless networks 12 are managed by different wireless operators who have agreed to allow the UE 14 to utilize either (or in this case, both) of the wireless networks 12-1, 12-2. While not shown for purposes of simplicity, the wireless networks 12 may implement mechanisms for traffic switching, steering and splitting using two wireless subscriptions using various individual functions. For example, the wireless networks 12 may include a mobility node that is operable to manage device registration, mobility management and/or security. The wireless networks 12 may include a data session handler node that is operable to manage data sessions and/or IP addressing. The wireless networks 12 may include a policy node that is operable to apply network policies, manage quality of service (QoS), and/or enforcing charging rules for users and applications. The wireless networks 12 may include a data traffic handling node that is operable to handle data traffic from a UE, including, for example, routing packets and otherwise managing communication between a UE and an external network. The wireless networks 12 may include a data management node that is operable to handle user authentication, store subscriber data, and/or manage access control across the network.

The UE 14 includes a processor device 16, a memory 18, and has been provisioned by the wireless operator 22 with two subscription identifiers 24-1 and 24-2 that correspond to two wireless subscriptions 26-1-26-2 that a user of the UE 14 has purchased from the wireless operator 22. The UE 14 can comprise any processing device, mobile or stationary, operable to communicate with two wireless networks and implement the functionality described herein. The two subscription identifiers 24-1 and 24-2 can take any suitable form and comprise any suitable information that the wireless network 12-1 can use to confirm that the UE 14 is permitted to access the wireless network 12-1 by virtue of having the wireless subscriptions 26-1 and 26-2. For example, the subscription identifiers 24-1 and 24-2 may be encrypted identifiers that, once decrypted by the wireless network 12-1, identify the corresponding wireless subscriptions 26-1 and 26-2.

In this example the UE 14 sends a registration request to the first wireless network 12-1. The registration request includes a request to connect to the first wireless network 12-1 and the subscription identifier 24-1 identifying the wireless subscription 26-1. The registration request also includes a dualsteer indication 28 that indicates that the UE 14 is capable of supporting a dualsteer (DS) mode utilizing the two wireless subscriptions 26-1 and 26-2. The term “dualsteer” as used herein refers to an ability of the UE 14 to connect to two wireless networks using the wireless subscriptions 26-1 and 26-2, as will be described in detail herein.

The first wireless network 12-1 confirms that the wireless subscription 26-1 is associated with the UE 14 and sends to the UE 14 a registration accept message that indicates that the first wireless network 12-1 supports the DS mode. The UE 14 may also receive from the first network 12-1 a policy data structure that may include, for example, a DS ID that correlates the first subscription 26-1 to the second subscription 26-2. The policy data structure may also include, by way of non-limiting example, one or more of network slice selection instructions identifying a set of network slices the UE 14 is permitted to use, one or more traffic steering policies that identify specific network paths for the UE 14 to use, and a roaming policy identifying one or more wireless networks to which the UE is permitted to roam, such as, for example, the wireless network 12-2.

The UE 14 may send to the first wireless network 12-1 a data services request to establish a first subscription data session 30 via the first wireless network 12-1 to an external network, such as the Internet 32. The data services request may include the DS ID. In some implementations the data services request may also include the subscription ID 24-2 associated with the subscription 26-2. The UE 14 receives from the first wireless network 12-1 a data session establishment accept message that includes DS rules 33 related to traffic steering between the first subscription data session and a second subscription data session. The UE 14 may then begin communicating with the Internet 32 via the first subscription data session 30.

The UE 14 may then detect the availability of the second wireless network 12-2. The UE 14 sends a registration request to the second wireless network 12-2. The registration request includes a request to connect to the second wireless network 12-2 and the subscription identifier 24-2 identifying the wireless subscription 26-2. The registration request also includes the dualsteer indication 28 that indicates that the UE 14 is capable of supporting the DS mode utilizing the two wireless subscriptions 26-1 and 26-2.

The second wireless network 12-2 may communicate with the first wireless network 12-1 to confirm that the wireless subscription 26-2 is associated with the UE 14 and sends to the UE 14 a registration accept message that indicates that the second wireless network 12-2 supports the DS mode. The UE 14 may also receive via the second network 12-2 a policy data structure that may include, for example, the DS ID that correlates the first subscription 26-1 to the second subscription 26-2. The policy data structure may also include, by way of non-limiting example, one or more of network slice selection instructions identifying a set of network slices the UE 14 is permitted to use, one or more traffic steering policies that identify specific network paths for the UE 14 to use, and a roaming policy identifying one or more wireless networks to which the UE is permitted to roam.

The UE 14 may send to the second wireless network 12-2 a data services request to establish a second subscription data session 34 via the second wireless network 12-2 to the Internet 32. The data services request may include the DS ID. In some implementations the data services request may also include the subscription ID 24-1 associated with the subscription 26-1. The data services request may also include an identifier of the first subscription data session 30. The UE 14 receives from the second wireless network 12-2 a data session establishment accept message that includes DS rules related to traffic steering using the first subscription data session 30 and the second subscription data session 34. In some implementations, the second subscription data session 34 may be routed through a data plane of the first wireless network 12-1, as illustrated by the second subscription data session 34′. The UE 14 may then begin communicating with the Internet 32 via the second subscription data session 34 while concurrently communicating with the Internet 32 via the first subscription data session 30.

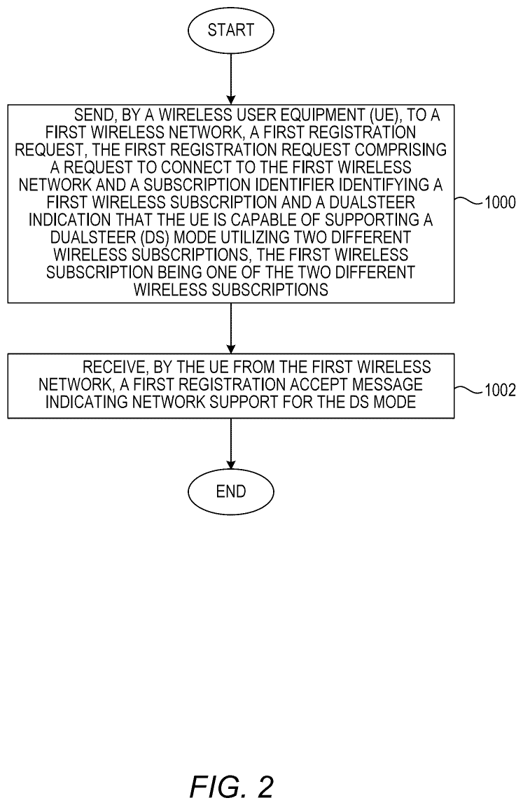

FIG. 2 is flowchart of a method, from a perspective of the UE 14, for implementing traffic switching, steering and splitting using two wireless subscriptions according to one implementation. The UE 14 sends, to the first wireless network 12-1, a first registration request, the first registration request including a request to connect to the first wireless network 12-1 and the subscription identifier 24-1 identifying the first wireless subscription 26-1, and the dualsteer indication 28 that the UE 14 is capable of supporting the DS mode utilizing the two wireless subscriptions 26-1 and 26-2 (FIG. 2, block 1000). The UE 14 receives, from the first wireless network 12-1, a first registration accept message indicating network support for the DS mode (FIG. 2, block 1002).

### 3GPP Example Implementation

An implementation of traffic switching, steering and splitting using two wireless subscriptions in a wireless network that complies with 3GPP specifications as modified as described herein, will now be discussed. While for ease of illustration and explanation various drawings refer to specific clauses, figures, tables and other portions of 3GPP TS 23.502 V18.4.0, the contents of which are incorporated herein by reference in their entirety, the examples disclosed herein are not limited to any particular 3GPP technical specification.

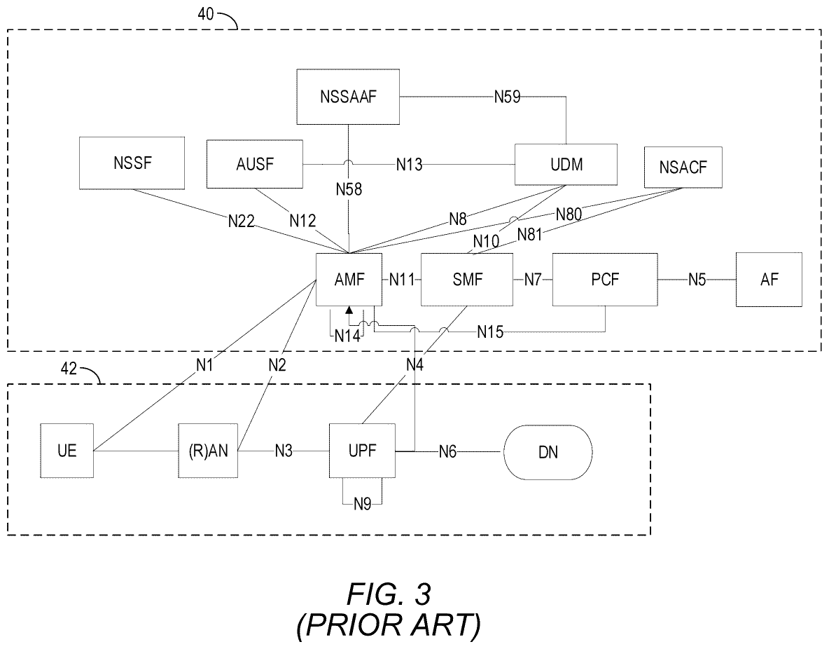

FIG. 3 is a block diagram of a non-roaming 5G system architecture. As discussed above, a wireless network may utilize various functions, such as, by way of non-limiting example, a mobility function (e.g., a mobility node), a data session handler function (e.g., a data session handler node), a policy function (e.g., a policy node), a data traffic handling function (e.g., a data traffic handling node), and a data management function (e.g., a data management node). In 5G a mobility node may be implemented by an access and mobility function (AMF) node, a data session handler node may be implemented by a session management function (SMF) node, a policy node may be implemented by a policy and control function (PCF) node, a data traffic handling node may be implemented by a user plane function (UPF) node, a data management node may be implemented by a unified data management function (UDM) node. However, in other networks, such as a 6G wireless network or a 7G wireless network, such functionality may be implemented by other-named functions, and the examples disclosed herein are not limited to any specific network architecture.

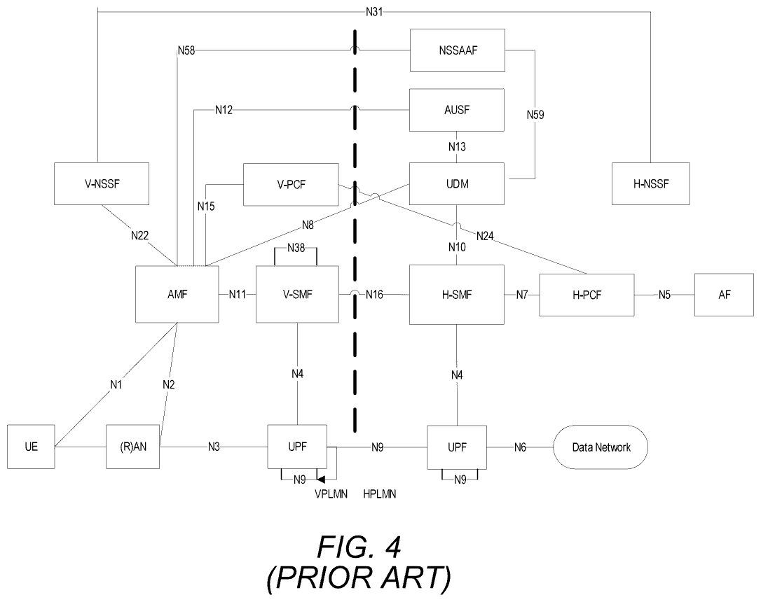

Reference to the 5G functions herein assume functionality as described in 3GPP TS 23.502 V18.4.0 for such functions, modified with additional functionality as described herein. While not illustrated, such functions are implemented on computing devices that have one or more hardware processor devices and memory. Such functions may be implemented on individual computing devices or one or more of such functions may be implemented on a same computing device. While also not explicitly illustrated, the functions are communicatively coupled to one another via one or more networks to facilitate message exchange. It is noted that the 5G system architecture includes a control plane 40 and a user plane 42. The user plane 42 identifies the components through which data exchanged between a UE and an external data network (DN) (e.g., the Internet) are communicated. FIG. 4 is a block diagram of a roaming 5G system architecture. When a UE is connected to a visited public land mobile network (VPLMN) various components of the VPLMN communicate with components in the home public land mobile network (HPLMN) of the UE to provide service to the UE.

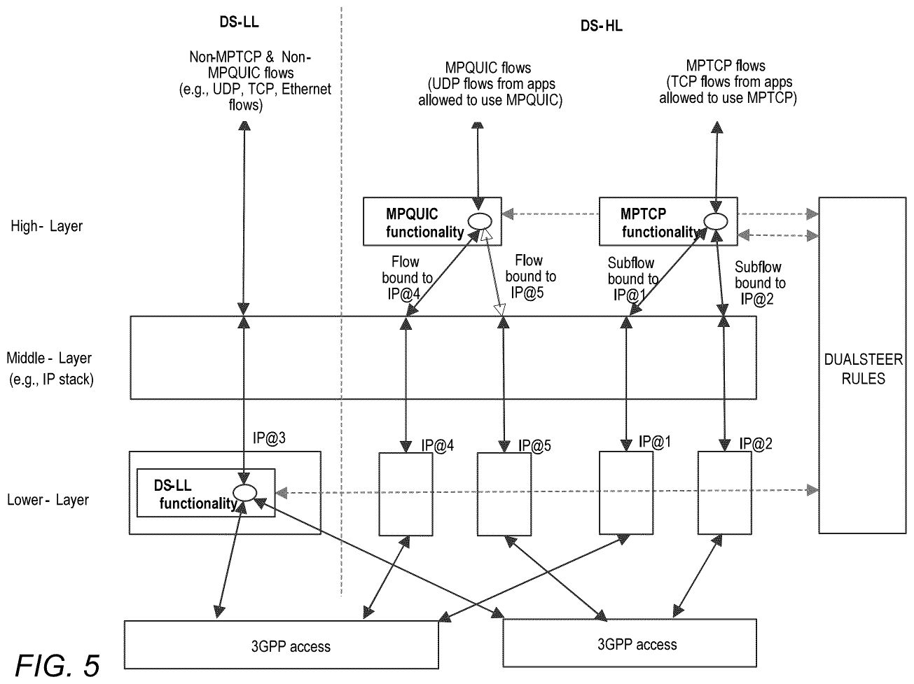

FIG. 5 is a block diagram illustrating aspects of a UE capable of implementing dualsteer functionality according to one implementation. In some implementations a UE may implement steering functionality (e.g., MPQUIC, MPTCP) in a manner similar, substantially similar, or identical to that described for ATSSS in clause 5.32.6.1. of 3GPP TS 23.501 V19.2.1 (2025-01) “Technical Specification 3rd Generation Partnership Project; Technical Specification Group Services and System Aspects; System architecture for the 5G System (5GS); Stage 2 (Release 19)” the contents of which are hereby incorporated herein by reference in their entirety.

### General

Certain terminology applies to the Figures throughout. In some implementations, the examples utilize two subscriptions (e.g., wireless subscriptions) from the same operator (e.g., wireless services provider). The subscriptions may be referred to herein as Subscription_A (e.g., SUPI_A) and Subscription_B (e.g., SUPI_B). The UE will be described as connecting to two PLMNs, PLMN1 and PLMN2. The UE may be referred to herein as a dualsteer UE. The reference to dualsteer in the term “dualsteer” UE refers to a UE modified to implement the functionality described herein. The UE connects to each PLMN using one of two subscriptions. Generally the figures illustrate the UE using SUPI_A to register to PLMN1, and SUPI_B to register to PLMN2.

While many of the examples illustrate the PLMN1 and PLMN2 as different PLMNs, the examples are not limited to the use of different PLMNs and also apply wherein PLMN1 and PLMN2 are the same PLMN.

By way of non-limiting example, the examples apply to various types of accesses, including:
1. Two New Radio (NR)/5g Core (5GC) accesses in a single PLMN (HPLMN or VPLMN) with each access being NR Terrestrial Network (TN) or NR Non-Terrestrial Network (NTN) (e.g., satellites);
2. Two NR/5GC accesses in two different PLMNs (including two VPLMNs or a VPLMN and the HPLMN) with each access being NR TN or NR NTN; or
3. Public Network-Integrated Non-Public Network (PNI-NPN) (integrated with the HPLMN or integrated with the VPLMN) and PLMN access (TN/NTN plus TN or NTN).

### Architecture Principles

The UE may use each subscription to establish a data session. The data sessions may be referred to as a first subscription data session and a second subscription data session to distinguish between the use of the first subscription to establish one data session and the second subscription to establish another data session. First and second does not imply an order of establishment in the context of the first subscription data session and the second subscription data session. Either the first subscription data session or the second subscription data session may be the initially established data session. The data sessions, in the context of 3GPP, are Protocol Data Unit (PDU) sessions.

The message sequence diagrams illustrated in the Figures correspond to certain clauses of 3GPP TS 23.502 V18.4.0, with bolded elements indicating how such clauses could be modified to implement traffic switching, steering and splitting using two wireless subscriptions according to one implementation. The messages in such diagrams may bear a designation (e.g., “21.” or “Clause 4.2.4.3”) that correspond to a particular action or actions bearing the same designation in 3GPP TS 23.502 V18.4.0. Due to spatial limitations and for purposes of simplicity and clarity only messages/actions with additional data for implementing traffic switching, steering and splitting using two wireless subscriptions are illustrated but it is assumed that such messages/actions take place in a sequence with other messages/actions as described in 3GPP TS 23.502 V18.4.0. For example, if a first message/action bearing the designation “1.” is followed by a second message/action bearing the designation “15.”, it is assumed that message/actions 2-14 as described in the referenced clauses of 3GPP TS 23.502 V18.4.0 are also implemented. Additionally, messages may illustrate, via non-bolded text, data elements that are conventional and described in 3GPP TS 23.502 V18.4.0. For purposes of illustration and clarity such data elements may not be described or discussed in detail herein.

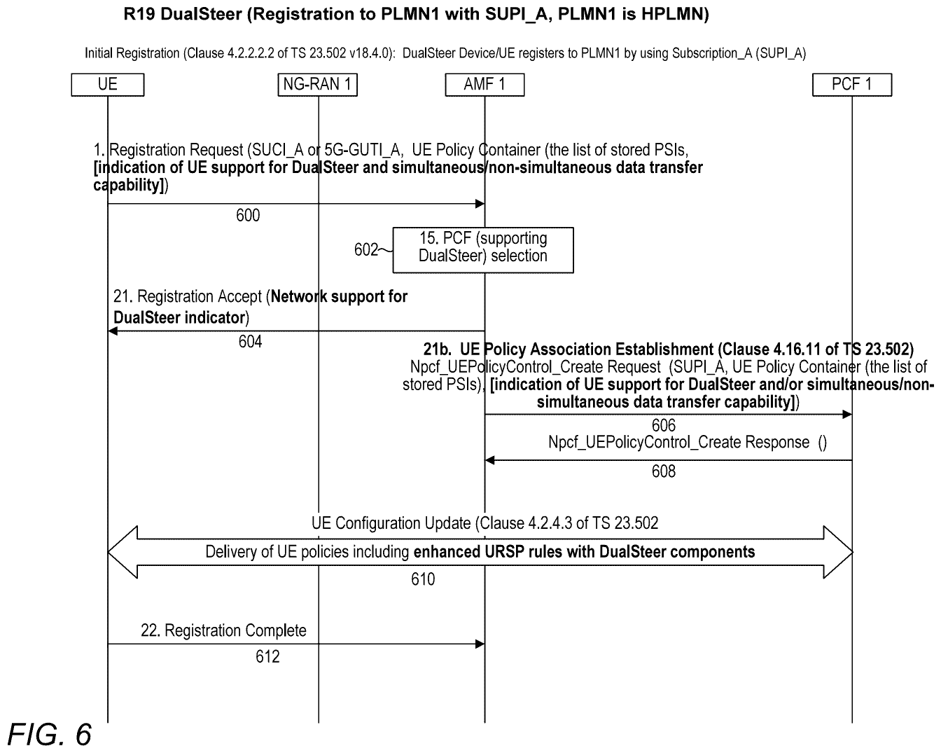

FIG. 6-8 illustrate examples of message sequences during a registration process between a UE and a 5G network according to some implementations. Generally, the UE will indicate in the registration request message its capabilities to support dualsteer and optionally, whether the UE is capable of simultaneous/non-simultaneous data transfer. In the registration accept message the AMF indicates to the UE whether the wireless network supports dualsteer. This indication allows the UE to know whether the UE can subsequently perform PDU Session Establishment procedures related to dualsteer. The AMF passes on the UE indication of dualsteer support and, optionally, simultaneous/non-simultaneous data transfer to a selected PCF. The PCF uses the dualsteer capability information to derive the UE Route Selection Policy (URSP) rules with the dualsteer related components and such rules to the UE.

FIG. 6 is a message sequence diagram illustrating a registration by a UE to a HPLMN wireless network using subscription A (e.g., SUPI_A) according to one implementation. The wireless network in this example is the HPLMN of the UE. At step 600, the UE sends a registration request message (e.g., a registration request to connect to a first wireless network) to an AMF 1 (via a RAN 1). It is noted throughout that a first element may be described as sending data to second element, and such data may be sent to the second element through one or more intermediary elements. For example, the UE (e.g., a first element) sends the registration request to the AMF 1 (e.g., a second element) through the RAN 1 (e.g., an intermediary element).

The registration request may include, in addition to other data, a subscription identifier (e.g., SUCI_A) that identifies or otherwise refers to a first wireless subscription, and a dualsteer indication of UE support for a dualsteer mode. In some implementations, the registration request may also include an indication whether the UE is capable of simultaneous data transfer (e.g., simultaneous data transfer capability) or only capable of non-simultaneous data transfer (e.g., non-simultaneous data transfer capability) over the data sessions using the two wireless subscriptions. In some implementations the DS indication may be simply an indication that the UE is capable of simultaneous data transfer.

At step 602 the AMF 1 selects a PCF 1. The AMF 1 selects the PCF 1 from other potential PCFs in part because the PCF 1 supports the DS mode. At step 604 the AMF 1 sends the UE a registration accept message that includes an indicator that the wireless network can support the DS mode.

The AMF 1 initiates a UE Policy association establishment procedure beginning at step 606. The AMF 1 sends the PCF 1 a Npcf_UEPolicyControl_Create Request that includes an indication of UE support for dualsteer. Optionally the request may include an indication that the UE is capable of simultaneous data transfer or only capable of non-simultaneous data transfer over the data sessions using the two wireless subscriptions. The PCF 1 uses the dualsteer capability information to derive the URSP rules with the dualsteer related components and subsequently deliver the rules to the UE, if the UE does not have the up-to-date URSP rules.

At step 608 the PCF 1 sends the AMF 1 a Npcf_UEPolicyControl_Create Response. At step 610 the PCF 1 delivers to the UE various UE policies including the enhanced UE Route Selection Policy (URSP) rules with DS related components, as will be described in greater detail below. It is noted that communications from the PCF 1 to the UE may travel through the AMF 1. At step 612 the UE indicates to the AMF 1 that registration is complete.

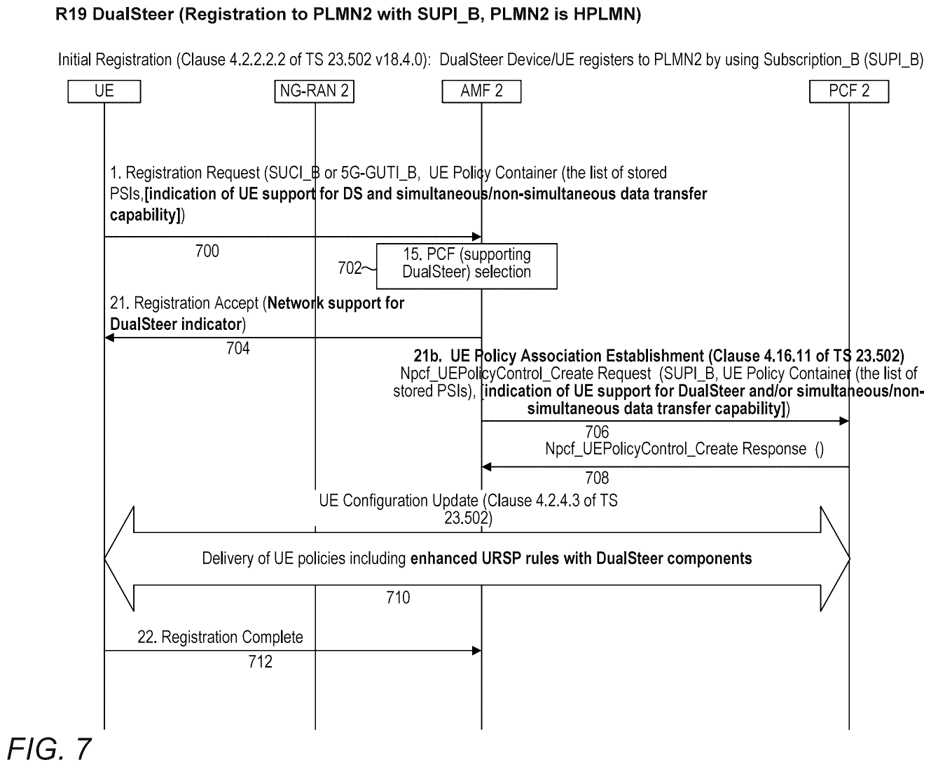

FIG. 7 is a message sequence diagram illustrating a registration by the UE to a HPLMN wireless network using subscription B (SUPI_B) according to one implementation. For example the registration in FIG. 6 might have been to a 5G wireless network of the HPLMN and the registration process illustrated in FIG. 7 may be to a 4G wireless network of the HPLMN of the UE. The steps 700-712 are substantially similar to the corresponding steps 600-612 illustrated in FIG. 6 except the communications relate to the UE, a RAN 2, AMF 2 and PCF 2 of the second wireless network.

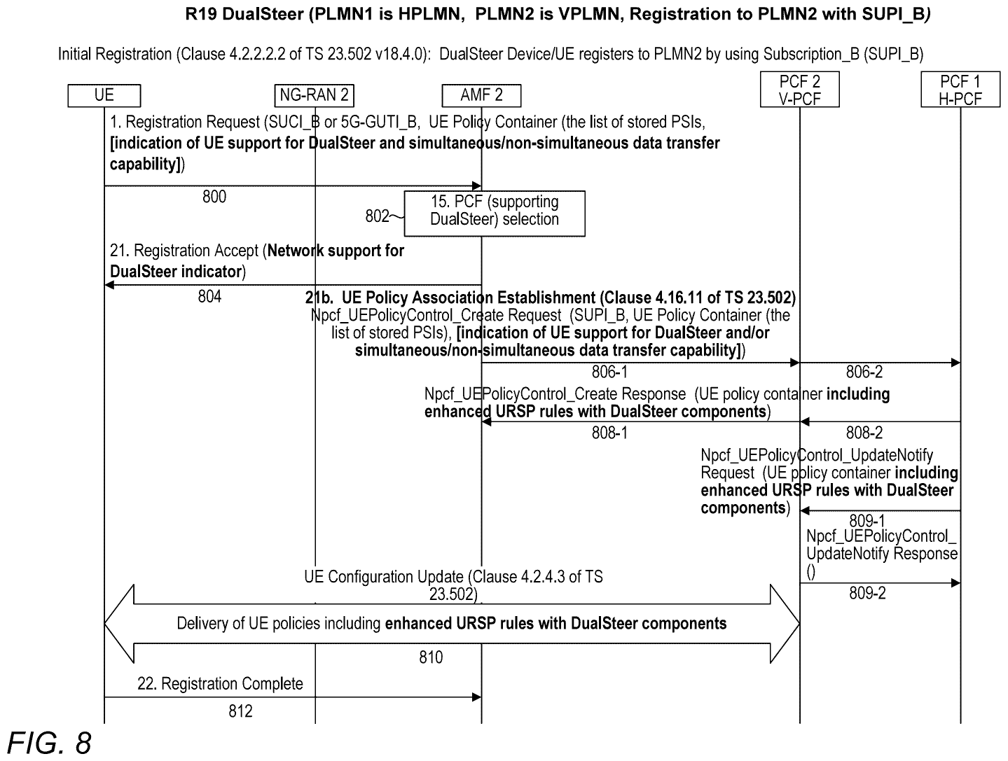

FIG. 8 is a message sequence diagram illustrating an alternate example to FIG. 7 wherein the UE registers to a VPLMN wireless network using subscription B according to one implementation. The steps 800-804 are substantially similar to the corresponding steps 700-704. In this example, however, the AMF 2 during UE Policy Association Establishment communicates with the PCF 1 (H-PCF) in steps 806 (806-1 and 806-2) and 808 (808-1 and 808-2) via the PCF-2 (V-PCF). At step 809-1 the PCF-2 (V-PCF) receives a Npcf_UEPolicyControl_UpdateNotify Request that includes the enhanced URSP rules with dualsteer components from the PCF 1 (H-PCF). At step 809-2 the PCF-2 (V-PCF) sends a Npcf_UEPolicyControl_UpdateNotify Response to the PCF 1 (H-PCF). At step 810 the PCF-2 (V-PCF) delivers to the UE various UE policies including the enhanced URSP rules with DS related components. At step 812 the UE indicates to the AMF 2 that registration is complete.

### URSP Route Selection Descriptor

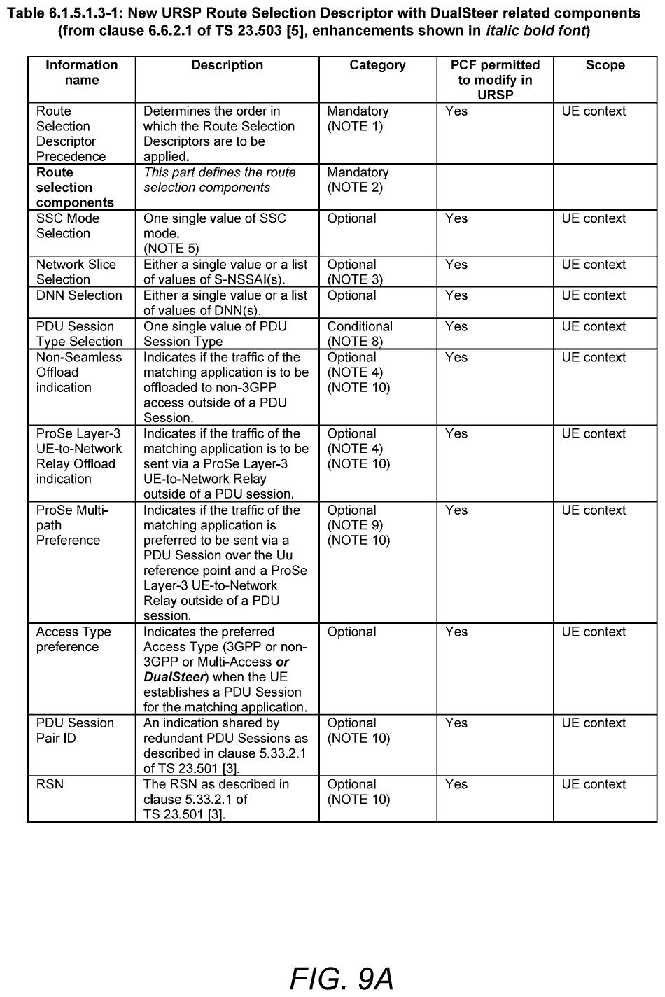

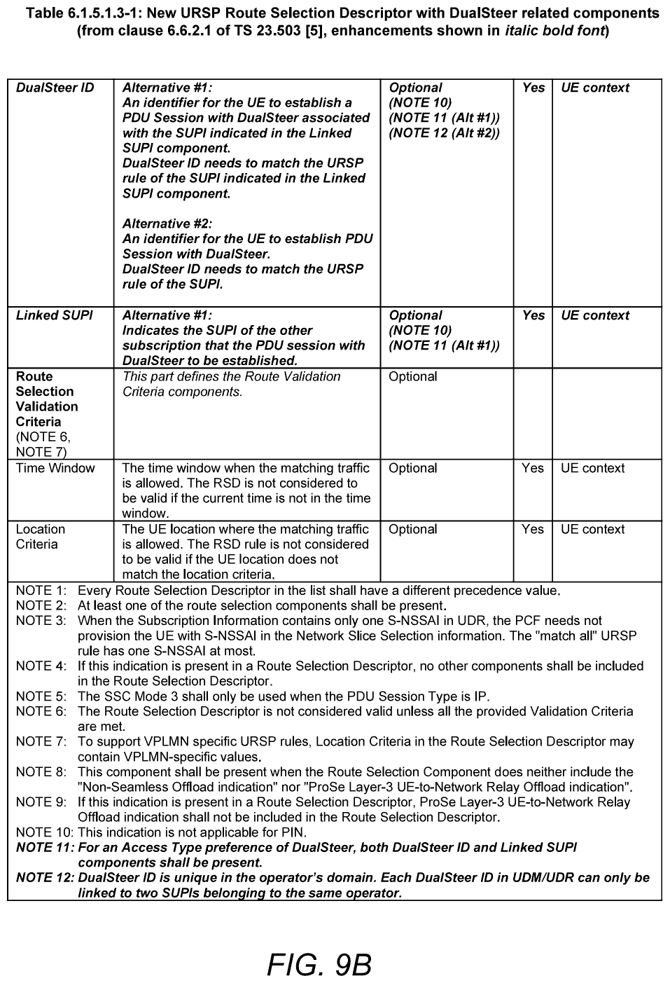

In some implementations the USRP Route Selection Descriptor described in clause 6.6.2.1 “Structure Description” of TS 23.503 (e.g., V19.2.0) “3rd Generation Partnership Project; Technical Specification Group Services and System Aspects; Policy and charging control framework for the 5G System (5GS); Stage 2 (Release 19)”, the contents of which are incorporated herein by reference in their entirety, may be modified to support the DS mode disclosed herein. FIGS. 9A-9B illustrate a modified Structure Description suitable for supporting the DS mode disclosed herein according to one implementation. Proposed modifications are illustrated in bold, non-bolded portions illustrate conventional aspects of a USRP Route Selection Descriptor. The proposed modifications include an additional information named dualsteer ID that has two alternatives, referred to sometimes herein as Alternative #1 and Alternative #2.

In Alternative #1 the dualsteer ID comprises an identifier for the UE to establish a PDU Session with dualsteer associated with the SUPI indicated in the Linked SUPI component. In Alternative #2 the dualsteer ID comprises an identifier for the UE to establish a PDU Session with dualsteer without the Linked SUPI component.

The proposed modifications also include an additional information named Linked SUPI (e.g., linked subscription) that is used in conjunction with Alternative #1 above. The Linked SUPI indicates the SUPI of the other subscription for which a PDU session is to be established. Note 11 indicates “For an Access Type preference of dualsteer, both dualsteer ID and Linked SUPI components shall be present.” Note 12 indicates “dualsteer ID is unique in the operator's domain. Each dualsteer ID in the Unified Data Management (UDM)/Unified Data Repository (UDR) can only be linked to two SUPIs belonging to the same operator.”

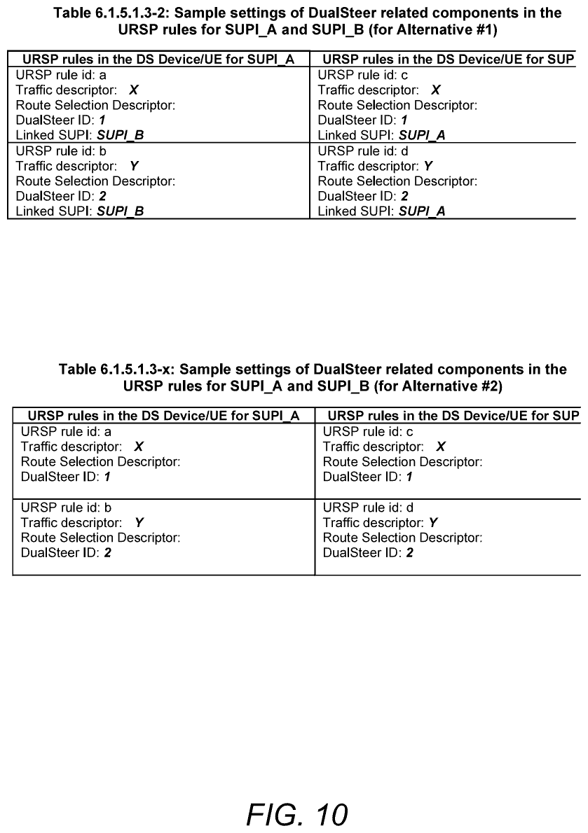

FIG. 10 illustrates, for alternative #1 and alternative #2, respectively, sample URSP rules for SUPI_A and SUPI_B for traffic descriptors of X and Y. Note that for the same traffic descriptor type, the dualsteer IDs in the URSP rules for SUPI_A and SUPI_B match. For example, for the traffic descriptor of X, the same dualsteer ID of 1 is assigned; and similarly for the traffic descriptor of Y, the same dualsteer ID of 2 is assigned. It may be the operator's responsibility to have matching URSP configurations for each SUPI such as disclosed in FIG. 10. Note that the settings of other components (e.g., DNN Selection, Network Slice Selection) of the URSP rules are not impacted and coexist with the dualsteer components.

### Subscription Management

Two subscriptions from the same operator do not need to be explicitly linked in the UDM/UDR for the URSP rule enhancement described in Alternative #1 above. For the URSP rule enhancements described in Alternative #2 above, the SM subscription data of each SUPI in the dualsteer UE can have the Linked SUPI information associated with each dualsteer ID.

The subscriptions can reside in different UDMs or in the same UDM.

The URSP rules of each subscription/SUPI are maintained in the PCF/UDR separately, such that each SUPI has its own URSP rules.

In some implementations dualsteer rules (sometimes referred to herein as “DS rules”) for traffic steering and switching may be similar to the ones specified for ATSSS rules as discussed above. Therefore, the applicable ATSSS steering functions (e.g., MPQUIC, MPTCP, and ATSSS-LL) and applicable ATSSS steering modes (e.g., Active-Standby, Priority-Based) can be used in the dualsteer rules. The Policy and Charging Control (PCC) rules, which are used to derive the dualsteer rules, are maintained in the PCF/UDR.

URSP rules of each SUPI in the PCF/UDR are enhanced with dualsteer components of the other SUPI(s) that can establish a dualsteer session. FIGS. 9A-9B illustrate a proposed updated URSP rule structure with the addition of dualsteer related components in the Route Selection Descriptor. As discussed above, two alternative URSP approaches are considered: alternative #1, wherein the URSP rules of each SUPI are enhanced with “dualsteer ID” and “Linked SUPI” attributes, and alternative #2, wherein the URSP rules of each SUPI is enhanced with only the “dualsteer ID” attribute.

As will be described in greater detail below, the new components “dualsteer ID” and “Linked SUPI” for Alternative #1 or “dualsteer ID” for Alternative #2 are sent by the dualsteer UE in the PDU Session Establishment message and the UL NAS Transport message containing the PDU Session Establishment message. The AMF considers these fields as indicators that the PDU session is for dualsteer. The AMF also uses the Linked SUPI to query the UDM of the Linked SUPI to get the H-SMF ID and H-PCF ID in use for the PDU session of the Linked SUPI if already activated (see, for example, clause 6.1.5.1.5).

### PDU Session Establishment

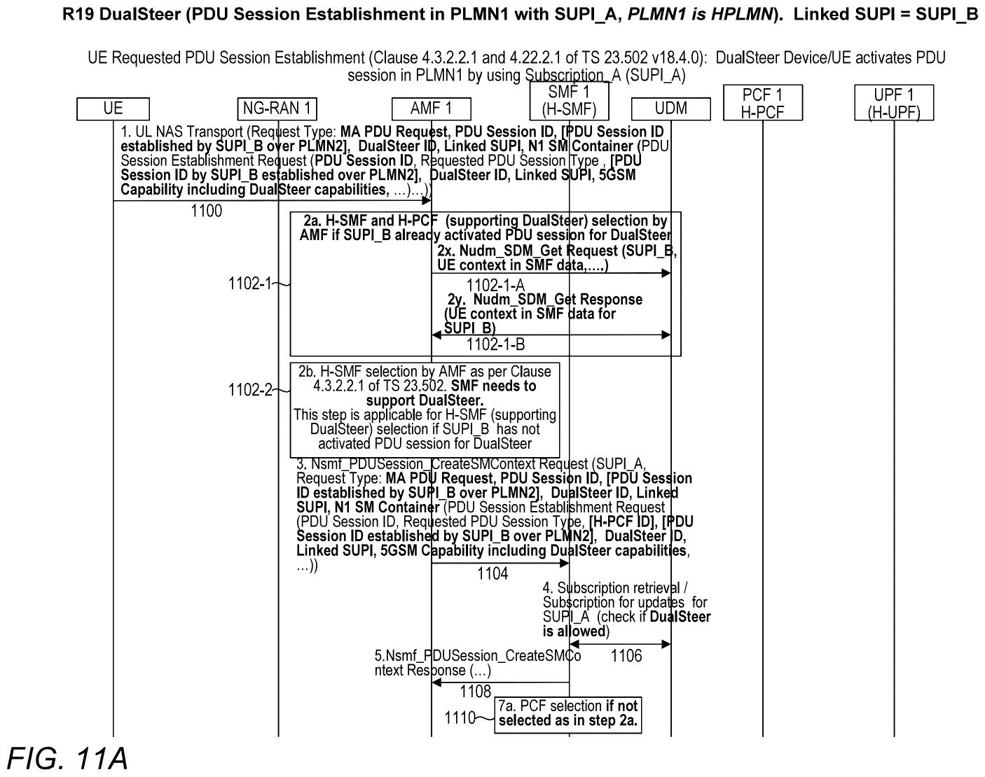

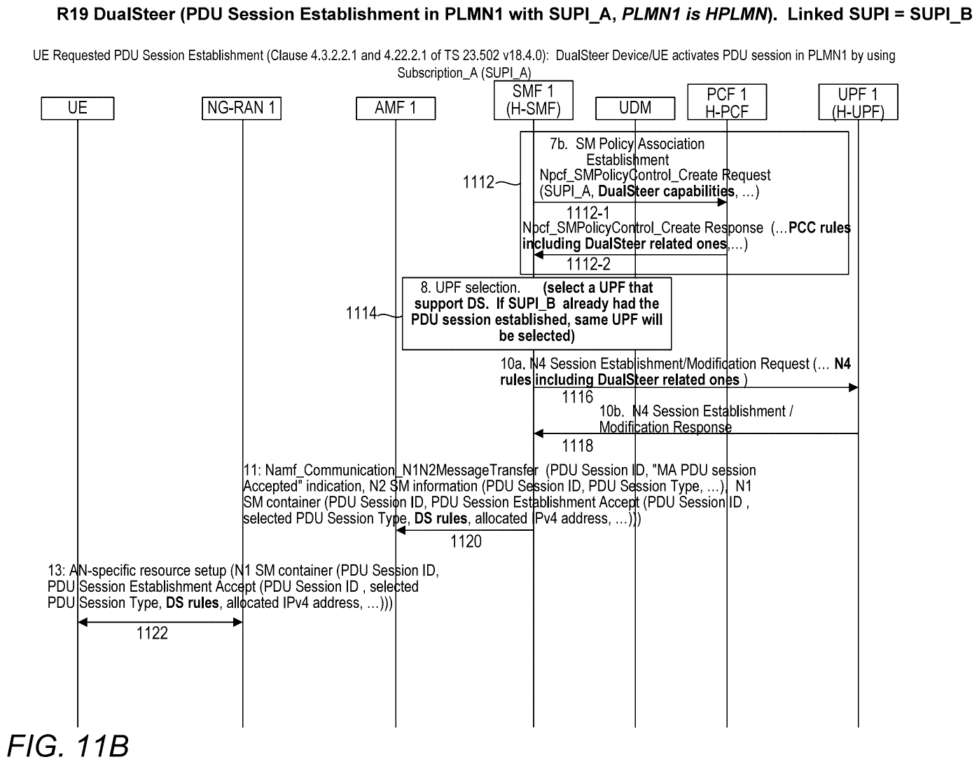

FIGS. 11-16 are message sequence diagrams illustrating PDU session establishment to implement traffic switching, steering and splitting using two wireless subscriptions according to some implementations.

There are a number of general principles of PDU session establishment. For a new application data, the dualsteer UE checks the URSP rules of the SUPI (e.g., SUPI_A), and if the dualsteer UE finds a matching URSP rule, the dualsteer UE initiates a PDU Session establishment procedure.

In some implementations the PDU session establishment for each SUPI (i.e., subscription) should be initiated in sequential order. In other words, upon successful establishment of the PDU session for SUPI_A, the dualsteer UE initiates the PDU Session establishment procedure for the other SUPI (e.g., SUPI_B). Sequential activation will help the AMF select the same H-SMF for the PDU sessions as described below.

The timing as to when the URSP rules for each SUPI in a dualsteer UE are used to trigger the PDU session establishments for each SUPI is left to the dualsteer UE implementation. Such activation could also be any time based on certain triggers such as Route Selection Validation Criteria in the URSP rules without requiring any application data trigger.

The PDU Session Establishment Request message and the UL NAS Transport message carrying the PDU Session Establishment Request message each carry the PDU Session ID, the dualsteer ID, the Linked SUPI (applicable only for Alternative #1 discussed above), and the PDU Session ID of the Linked SUPI (if the PDU session has already been established by the UE).

It is not required that the PDU Session IDs assigned by the DS UE for each SUPI are the same, but the same PDU Session ID can be used.

The 5GSM Capability IE in the PDU Session Establishment Request message may include the dualsteer capabilities including supported steering functions (e.g., MPTCP, MPQUIC, DS-LL), supported steering modes (e.g. Active-Standby, etc.), and support for simultaneous or non-simultaneous data transfer.

The AMF selects an H-SMF (and V-SMF in case of Home-Routed PDU session) that is capable of supporting dualsteer. The dualsteer capabilities information will allow the AMF to select an H-SMF that matches the dualsteer capabilities of the UE.

Alternative #1: If the PDU Session ID of the Linked SUPI IE is included in the UL NAS Transport message, the AMF queries the UDM/UDR by using the Linked SUPI IE to receive the UE context in SMF Data of the Linked SUPI. The AMF matches the received UE context information with the PDU Session ID of the Linked SUPI to identify the H-SMF ID and PCF ID to be used for the PDU Session.

Alternative #2: If the PDU Session ID of the Linked SUPI IE is included in the UL NAS Transport message, the AMF queries the UDM/UDR by using the dualsteer ID IE to receive the UE context in SMF Data of the Linked SUPI. The AMF matches the received UE context information with the PDU Session ID of the Linked SUPI to identify the H-SMF ID and PCF ID to be used for the PDU Session.

To allow the AMF to query the UDM/UDR by using the dualsteer ID as a key for the UE context in SMF Data, the SMF registration to the UDM and the UE context in SMF Data structure are enhanced with the dualsteer ID component.

The AMF sends to the selected H-SMF (or V-SMF) the Nsmf_PDUSession_CreateSMContext Request message with the PDU Session ID, the dualsteer ID, the Linked SUPI (optional for Alternative #2), the PDU Session ID of the Linked SUPI (if received from the DS UE) and the PDU Session Establishment Request.

If the PCF ID (e.g., the H-PCF ID) used by the Linked SUPI's PDU session is identified by the AMF, the PCF ID is also included.

In some implementations the H-SMF retrieves the SM subscription data in the UDM to check whether dualsteer is allowed for the SUPI and Linked SUPI associated with the dualsteer ID (for Alternative #2).

The H-SMF performs SM Policy Association Establishment with the H-PCF by including dualsteer capabilities of the SUPI. Based on the dualsteer capabilities of the DS UE, the H-PCF derives applicable PCC rules. In the response message the H-PCF provides the PCC rules including the dualsteer related ones.

The H-SMF establishes/modifies the N4 Session with the selected H-UPF (PSA UPF) by including the N4 rules with the dualsteer related rules. A common N4 session for SUPI_A and SUPI_B is established between the H-SMF and the PSA-UPF.

The H-SMF sends the PDU Session Establishment Accept message with the DS Rules via the AMF (and V-SMF).

The same IP address/prefix (e.g., IP@3 in FIG. 5) may be allocated to the DS UE.

FIGS. 11A-11B are a message sequence diagram illustrating a Multi-Access (MA) PDU session establishment by the UE with PLMN1 using SUPI_A (i.e., subscription A) under alternative #1 above, identifying the Linked SUPI_B. In this example, PLMN1 is the HPLMN of the UE. The terms “linked SUPI” as used herein refers to an identifier of the linked wireless subscription. At step 1100 the DS UE sends a UL NAS Transport message (e.g., a data services request to establish a first subscription data session) to the AMF that includes, among other information, the following information: (Request Type: MA PDU Request, PDU Session ID (e.g., a subscription data session ID), [PDU Session ID established by SUPI_B over PLMN2], dualsteer ID, Linked SUPI (e.g., information that identifies the second wireless subscription such as a second subscription ID), N1 SM Container (PDU Session Establishment Request (PDU Session ID, Requested PDU Session Type, [PDU Session ID by SUPI_B established over PLMN2] (e.g., a second subscription data session ID, if already established), dualsteer ID (e.g., information that may be used to determine the second wireless subscription), Linked SUPI, 5GSM Capability including dualsteer capabilities, . . . ) . . . )). Bolded terms in the Figures indicate information used to implement DS capabilities in addition to conventional data that may be identified in a UL NAS Transport message as disclosed in clause 4.3.2.2.1 and 4.22.2.1 of TS 23.502 v18.4.0.

The sending of the UL NAS Transport message may be based on the UE finding a matching URSP rule. In the PDU Session Establishment Request and the UL NAS Transport message carrying the PDU Session Establishment Request, the DS UE includes the PDU Session ID (for SUPI_A), the dualsteer ID, the Linked SUPI (which in this example, is SUPI_B), and the PDU Session ID of the Linked SUPI if the UE had previously established a PDU session using SUPI_B in the PLMN2. The dualsteer ID and Linked SUPI are derived from the URSP rules of SUPI_A.

The PDU Session Establishment Request message may include a 5GSM Capability IE. The 5GSM Capabilities IE includes the dualsteer capabilities including supported steering functions (e.g., MPTCP, MPQUIC, DS-LL), supported steering modes (e.g., Active-Standby, etc.), and optionally, support for simultaneous or non-simultaneous data transfer.

The PDU Session IDs assigned by the DS UE for each SUPI are not required to be the same, but the same PDU Session ID can be used.

The AMF 1 receives the UL NAS transport message. If SUPI_B (e.g., the Linked SUPI) has a PDU session already established (i.e., the UE has previously established a PDU session using SUPI_B) and the corresponding PDU Session ID is included in the PDU Session ID of the Linked SUPI in the UL NAS Transport message, at step 1102-1 the AMF 1 queries the UDM of the Linked SUPI to receive the UE context in the SMF Data of the Linked SUPI. For example, the AMF 1 may send a Nudm_SDM_Get Request (SUPI_B, UE context in SMF data, . . . ) message to the UDM at step 1102-1-A. At step 1102-1-B, the AMF 1 receives a response from the UDM that includes the UE context in the SMF data for the SUPI_B). The AMF 1 matches the received UE context information with the PDU Session ID of the Linked SUPI to identify the H-SMF ID and the PCF ID to be used for the requested PDU Session, such that both PDU data sessions utilize the same H-SMF and PCF.

If the PDU Session ID of the linked SUPI is not included in the UL NAS Transport message, at step 1102-2 the AMF 1 selects an SMF 1 (an H-SMF) supporting dualsteer. At step 1104 the AMF 1 sends to the selected SMF 1 (H-SMF) the Nsmf_PDUSession_CreateSMContext Request message with the PDU Session ID, the dualsteer ID, the Linked SUPI, the PDU Session ID of the Linked SUPI (if received from the DS UE) and the PDU Session Establishment Request. If the PCF ID (i.e., the H-PCF ID) used by the Linked SUPI's PDU session is identified by the AMF 1 as discussed in step 1102-1, the PCF ID is also included.

At step 1106 the SMF 1 retrieves the Session Management (SM) subscription data of SUPI_A in the UDM to determine whether dualsteer is allowed for SUPI_A.

At step 1110 the H-SMF selects a PCF supporting dualsteer if the PCF ID was not identified by the AMF 1 in step 1102-1 and not included in the message sent to the SMF 1 in step 1104.

Referring now to FIG. 11B, step 1112 relates to SM Policy Association Establishment. In particular, at step 1112-1 the SMF 1 includes the dualsteer capabilities of SUPI_A in the Npcf_SMPolicyControl_Create Request to the PCF 1. At step 1112-2 the PCF 1 responds with a Npcf_SMPolicyControl_Create Response that includes the PCC rules including the dualsteer related rules.

At step 1114 the SMF 1 selects a UPF 1 that supports the DS mode. If the PDU session for SUPI_B was already established, the SMF 1 selects the same UPF used for the PDU session for SUPI_B.

At step 1116 the SMF 1 establishes the N4 Session with the UPF 1. The SMF 1 includes the N4 rules with the dualsteer rules.

At step 1118 the UPF 1 responds with a N4 Session Establishment/Modification Response.

At step 1120 the SMF 1 sends to the AMF 1 a Namf_Communication_N1N2MessageTransfer message including the PDU Session Establishment Accept message which includes the DS rules.

At step 1122 the RAN 1 sends the PDU Session Establishment Accept message which includes the DS rules to the UE.

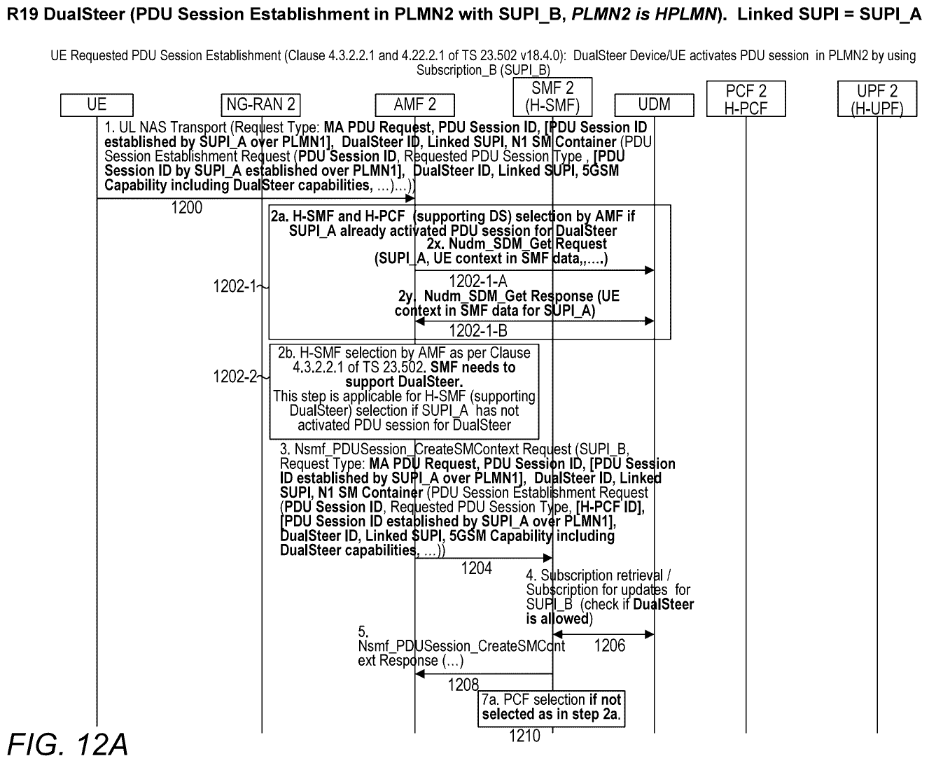

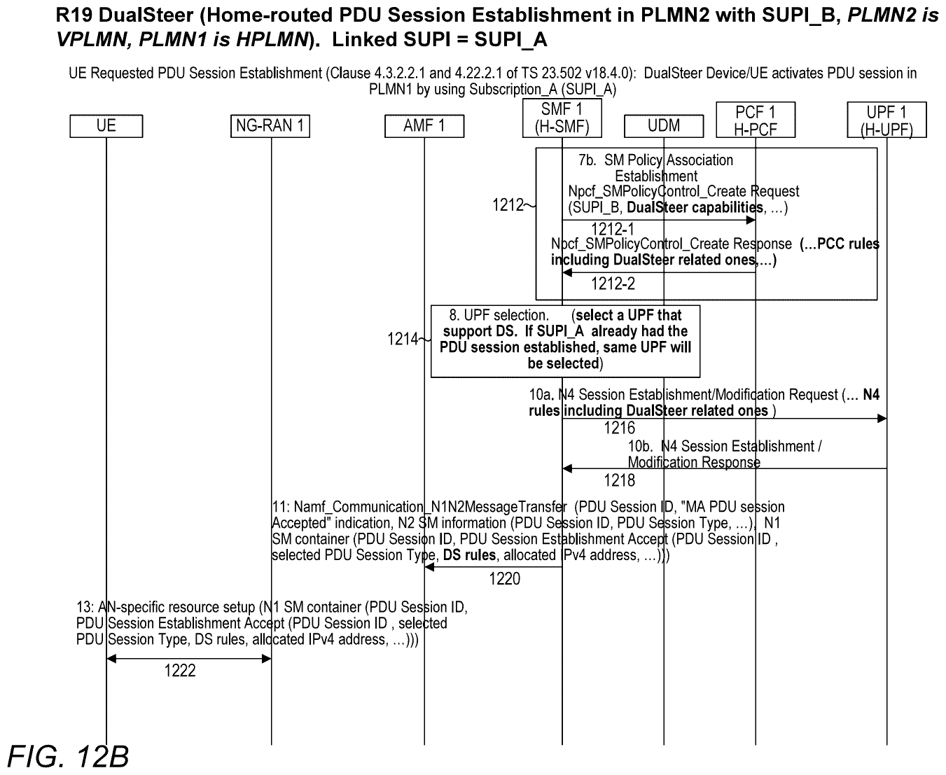

FIGS. 12A-12B are a message sequence diagram illustrating a Multi-Access (MA) PDU session establishment by the UE with PLMN2 using SUPI_B (i.e., subscription B) under alternative #1, identifying the Linked SUPI_A. In this example, PLMN2 is also the HPLMN of the UE. The steps 1200-1222 are substantially similar to the corresponding steps 1100-1122 illustrated in FIGS. 11A-11B and for the sake of brevity will not be repeated herein.

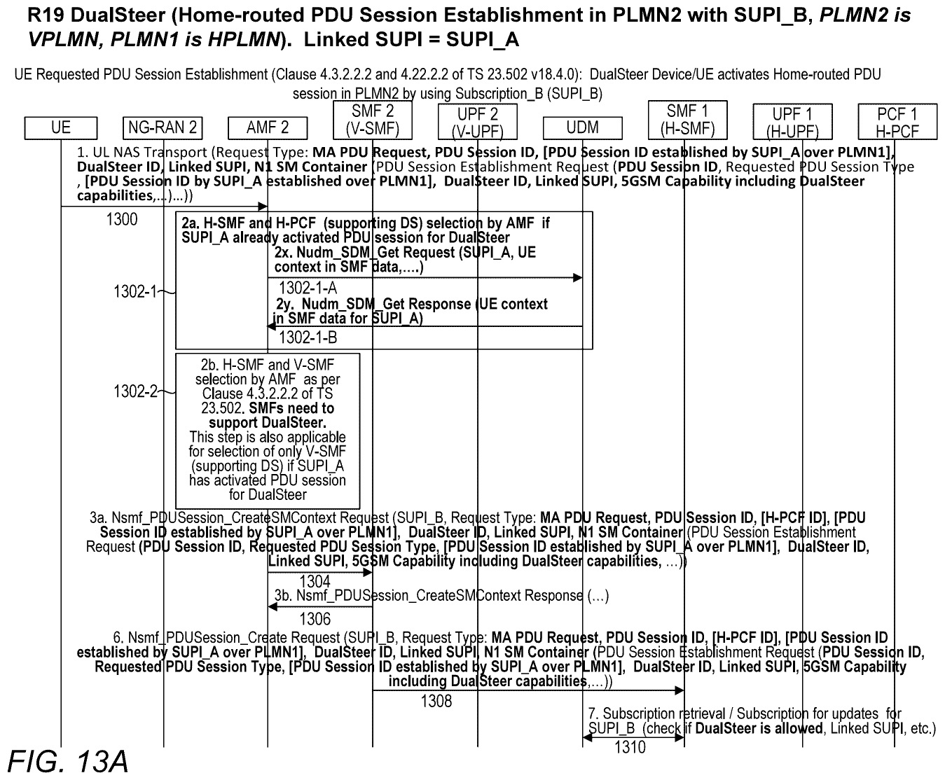

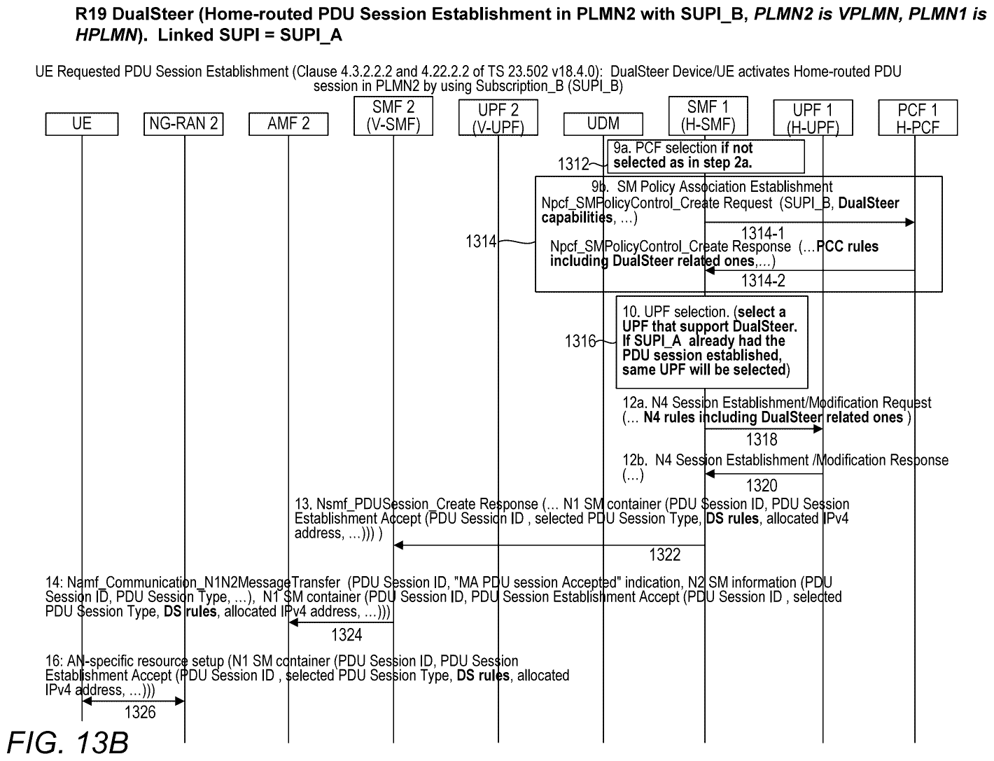

FIGS. 13A-13B are a message sequence diagram illustrating a Multi-Access (MA) PDU session establishment by the UE with PLMN2 using SUPI_B (i.e., subscription B) under alternative #1 above, identifying the Linked SUPI_A. In this example, PLMN2 is a VPLMN of the UE. The signalling flow in FIGS. 13A-13B is similar to that illustrated in FIGS. 11A-11B, except the AMF 2 is a V-AMF and communication with the SMF 1 (H-SMF) takes place via the SMF 2 (V-SMF).

At step 1300, based on finding a matching URSP rule, the DS UE initiates a PDU session establishment using SUPI_B. In the PDU Session Establishment Request and the UL NAS Transport message carrying the PDU Session Establishment Request, the DS UE includes the PDU Session ID (for SUPI_B), the DS ID, the linked SUPI (e.g., SUPI_A), and the PDU Session ID of the linked SUPI (if the UE previously established the PDU session in PLMN1 using SUPI_A). The DS ID and the linked SUPI are derived from the URSP rules of SUPI_B.

The PDU Session Establishment Request message includes a 5GSM Capability IE. The 5GSM Capabilities IE include the DS capabilities including supported steering functions (e.g., MPTCP, MPQUIC, DS-LL), supported steering modes (e.g., Active-Standby, etc.), and support for simultaneous or non-simultaneous data transfer.

As before, the PDU Session IDs assigned by the DS UE for each SUPI are not required to be the same, but same PDU Session ID can also be used.

At step 1302-1 if SUPI_A (e.g., Linked SUPI) has a PDU session already established and the corresponding PDU Session ID is included in the PDU Session ID of the linked SUPI in the UL NAS Transport message, the AMF 2 queries the UDM of the Linked SUPI to receive the UE context in the SMF Data of the Linked SUPI. For example, the AMF 2 may send a Nudm_SDM_Get Request (SUPI_A, UE context in SMF data, . . . ) message to the UDM at step 1302-1-A. At step 1302-1-B the AMF 2 receives a response from the UDM that includes the UE context in the SMF data for the SUPI_A). The AMF 2 matches the received UE context information with the PDU Session ID of the Linked SUPI to identify the H-SMF ID and the PCF ID to be used for the PDU Session, such that both PDU data sessions utilize the same H-SMF and PCF.

If the PDU Session ID of the linked SUPI is not included in the UL NAS Transport message, at step 1302-2 the AMF 2 selects an H-SMF and a V-SMF supporting DS. If the PDU Session ID of the Linked SUPI is included in the UL NAS Transport message, the AMF 2 selects only a SMF 2 (a V-SMF) supporting DS.

At step 1304 the AMF 2 sends to the selected SMF 2 (V-SMF) the Nsmf_PDUSession_CreateSMContext Request message with PDU Session ID, the dualsteer ID, the Linked SUPI, the PDU Session ID of the Linked SUPI (if received from the DS UE) and the PDU Session Establishment Request. If the PCF ID (i.e., H-PCF ID) used by the Linked SUPI's PDU session is identified by the AMF 2 in step 2a, the PCF ID is also included. At step 1306 the SMF 2 sends a Nsmf_PDUSession_CreateSMContext Response to the AMF 2.

At step 1308 the SMF 2 (V-SMF) sends to the SMF 1 (H-SMF) the Nsmf_PDUSession_Create Request message with the PDU Session ID, the DS ID, the linked SUPI, the PDU Session ID of the Linked SUPI (if received from the DS UE) and the PDU Session Establishment Request.

At step 1310, the SMF 1 (H-SMF) retrieves the SM subscription data of SUPI_B in the UDM to determine whether DS mode is allowed for SUPI_B.

Referring now to FIG. 13B, at step 1312, the SMF 1 (H-SMF) selects a PCF supporting DS if the PCF ID was not identified by the AMF 2 in 1302-1 and not included in the message sent to the SMF 2 in steps 1304 and 1308.

Step 1314 relates to SM Policy Association Establishment. In particular, at step 1314-1 the SMF 1 (H-SMF) performs the SM Policy association establishment with the PCF 1 (H-PCF) by including dualsteer Capabilities of SUPI_B. At step 1314-2, the response message from the PCF 1 (H-PCF) includes the PCC rules including the dualsteer related rules.

At step 1316 the SMF 1 (H-SMF) selects a UPF 1 (H-UPF). If the PDU session for SUPI_A had already been established, the SMF 1 (H-SMF) selects the same UPF 1 (H-UPF).

At step 1318 the SMF 1 (H-SMF) establishes the N4 Session with the UPF 1 (H-UPF) by sending a N4 Session Establishment/Modification Request that includes the N4 rules with the dualsteer related rules.

At step 1320 the SMF 1 (H-SMF) receives a N4 Session Establishment/Modification Response from the UPF 1 (H-UPF).

At step 1322 the SMF 1 (H-SMF) sends to the SMF 2 (V-SMF) the Nsmf_PDUSession_Create Response message including the PDU Session

Establishment Accept message which includes the DS rules. The same UE IP address, which was allocated for the PDU Session for SUPI_A, is allocated.

At step 1324 the SMF 2 (V-SMF) sends to the AMF 2 the Namf_Communication_N1N2MessageTransfer message including the PDU Session Establishment Accept message which includes the DS rules.

At step 1326 the RAN 2 sends the PDU Session Establishment Accept message which includes the DS rules to the DS UE.

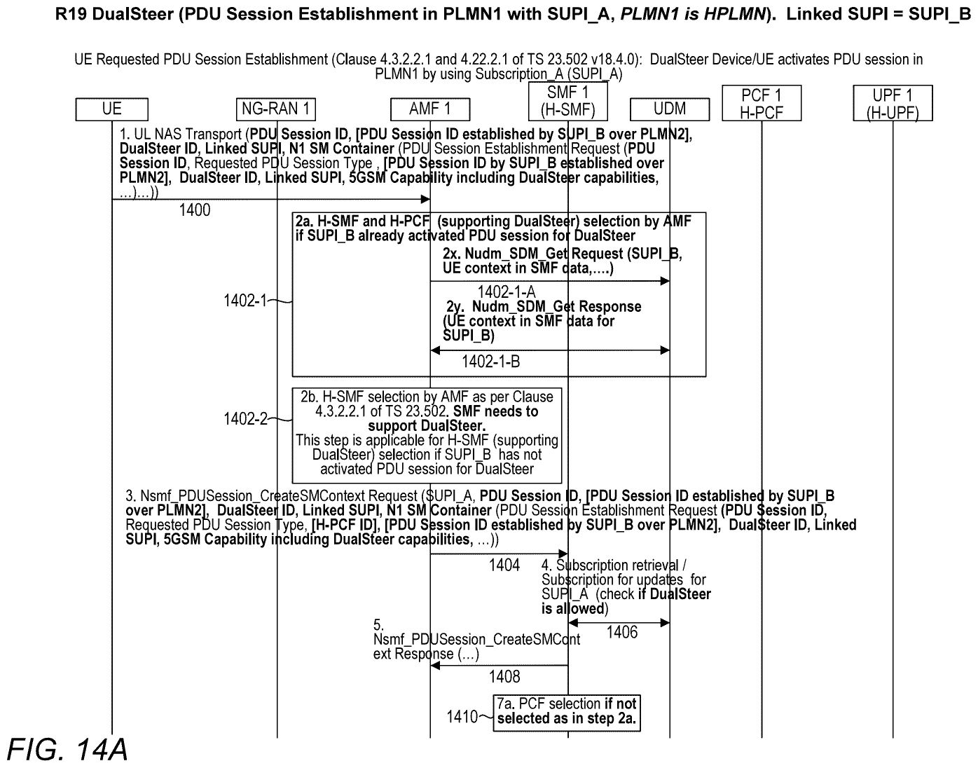

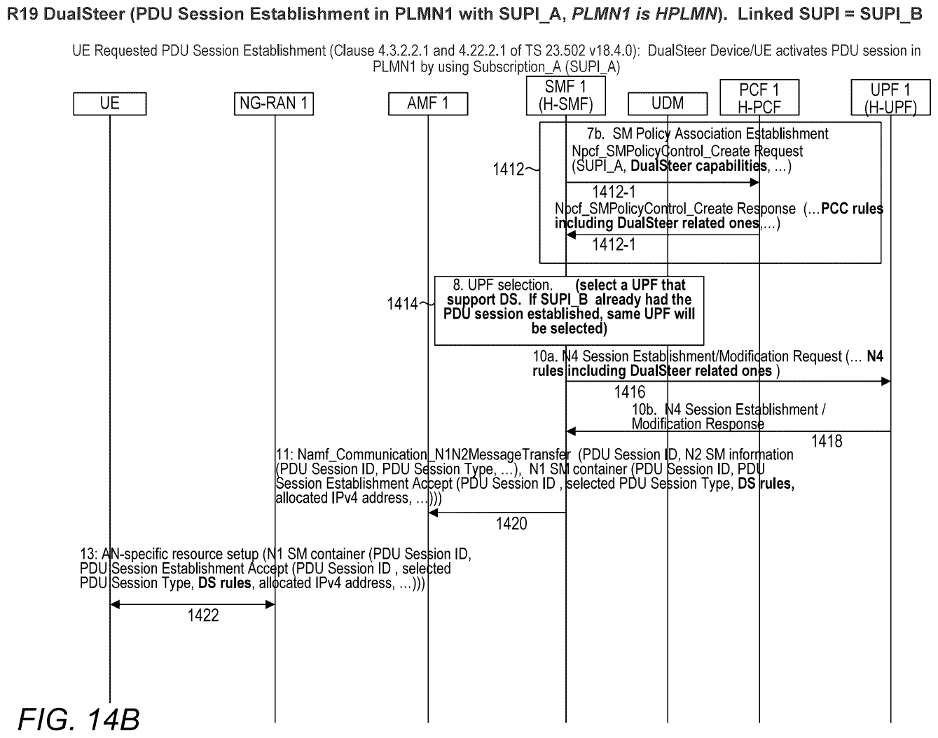

FIGS. 14A-14B are a message sequence diagram illustrating a regular PDU session establishment by the UE with PLMN1 using SUPI_A (i.e., subscription A) under alternative #1 above, identifying the Linked SUPI_B. In this example, PLMN1 is the HPLMN of the UE. Steps 1400-1422 are substantially similar to the corresponding steps 1100-1122 illustrated in FIGS. 11A-11B and for the sake of brevity will not be repeated herein.

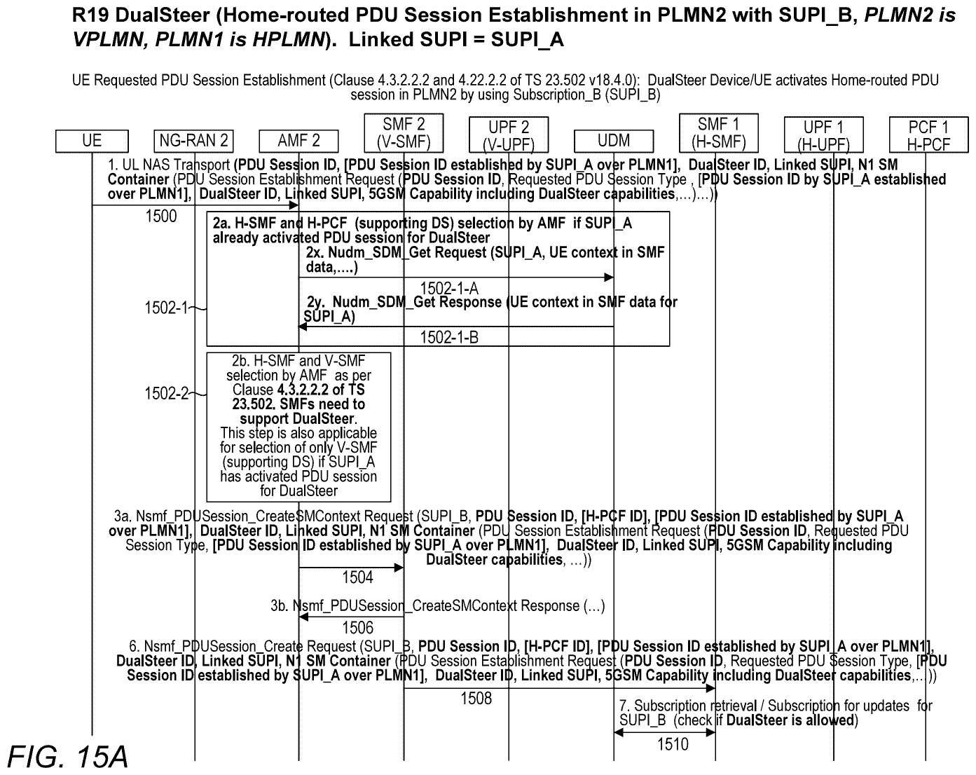

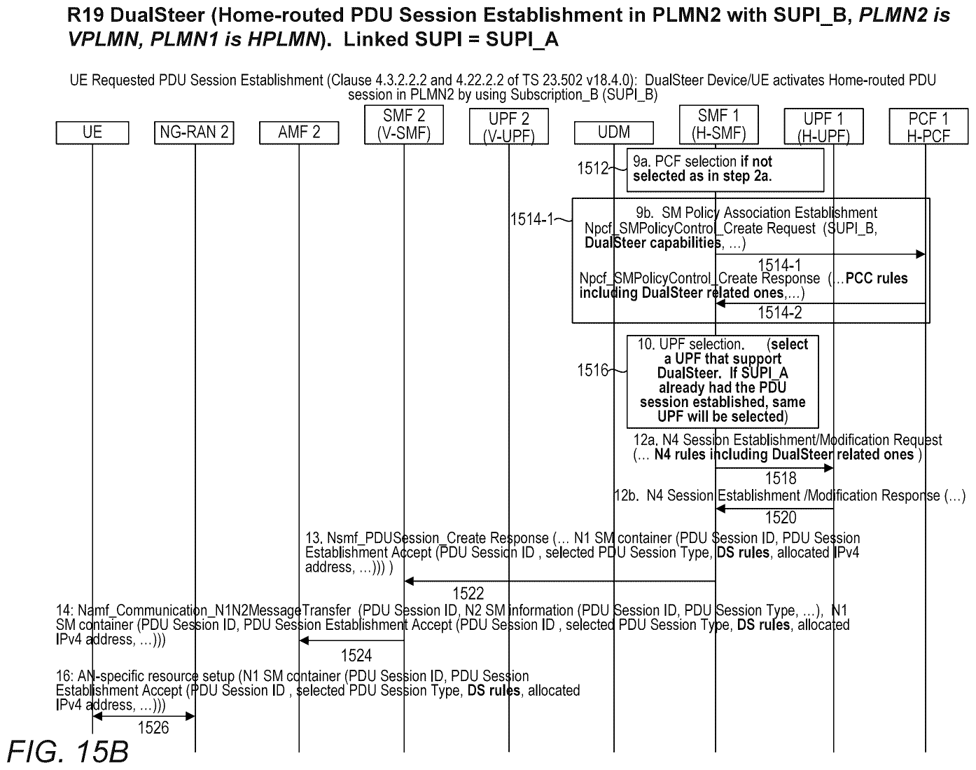

FIGS. 15A-15B are a message sequence diagram illustrating a PDU session establishment by the UE with PLMN2 using SUPI_B (i.e., subscription B) under alternative #1 above, identifying the Linked SUPI_A. In this example, PLMN2 is a VPLMN of the UE. Steps 1500-1526 are substantially similar to the corresponding steps 1300-1326 illustrated in FIGS. 13A-13B and for the sake of brevity will not be repeated herein.

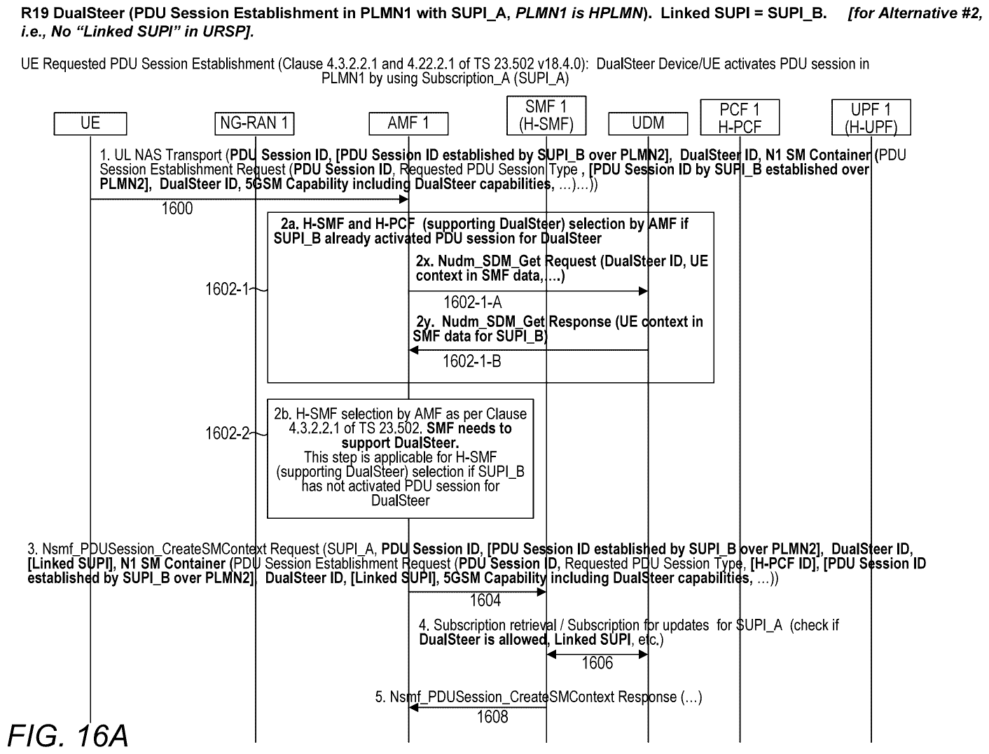

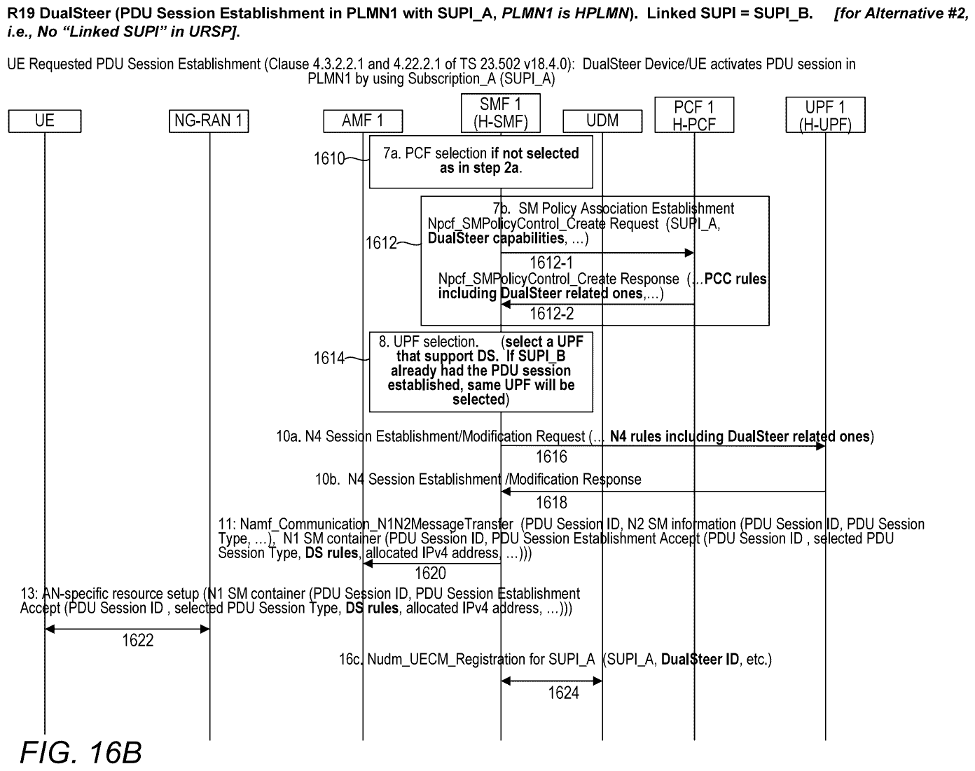

FIGS. 16A-16B are a message sequence diagram illustrating PDU session establishment by the UE with PLMN1 using SUPI_A (i.e., subscription A) under alternative #2 above, such that the Linked SUPI_B is not identified in the UL NAS Transport/PDU Session Establishment Request message. In this example, PLMN1 is the HPLMN of the UE. Steps 1600-1622 are substantially similar to the corresponding steps 1400-1422 illustrated in FIGS. 14A-14B, which in turn are substantially similar to the corresponding steps 1100-1122 of FIGS. 11A-11B, and for the sake of brevity will not be repeated herein, except as discussed below.

At step 1600 the Linked SUPI IE is not included in the UL NAS Transport/PDU Session Establishment Request message.

At step 1602-1 if SUPI_B (e.g., the Linked SUPI) has a PDU session already established and the corresponding PDU Session ID is included in the PDU Session ID of the Linked SUPI in UL NAS Transport message, the AMF 1 queries the UDM of the Linked SUPI by using the DS ID to receive the UE context in SMF Data. The AMF matches the received UE context information with the PDU Session ID of the Linked SUPI to identify the H-SMF ID and the PCF ID to be used for the PDU Session.

At step 1604, the Linked SUPI is included if received in successful execution of step 1602-1.

At step 1606 the H-SMF retrieves the SM subscription data of SUPI_A including the Linked SUPI information associated with the dualsteer ID.

At step 1624 the SMF registers to the UDM including the DS ID component by using Nudm_UECM_Registration signaling.

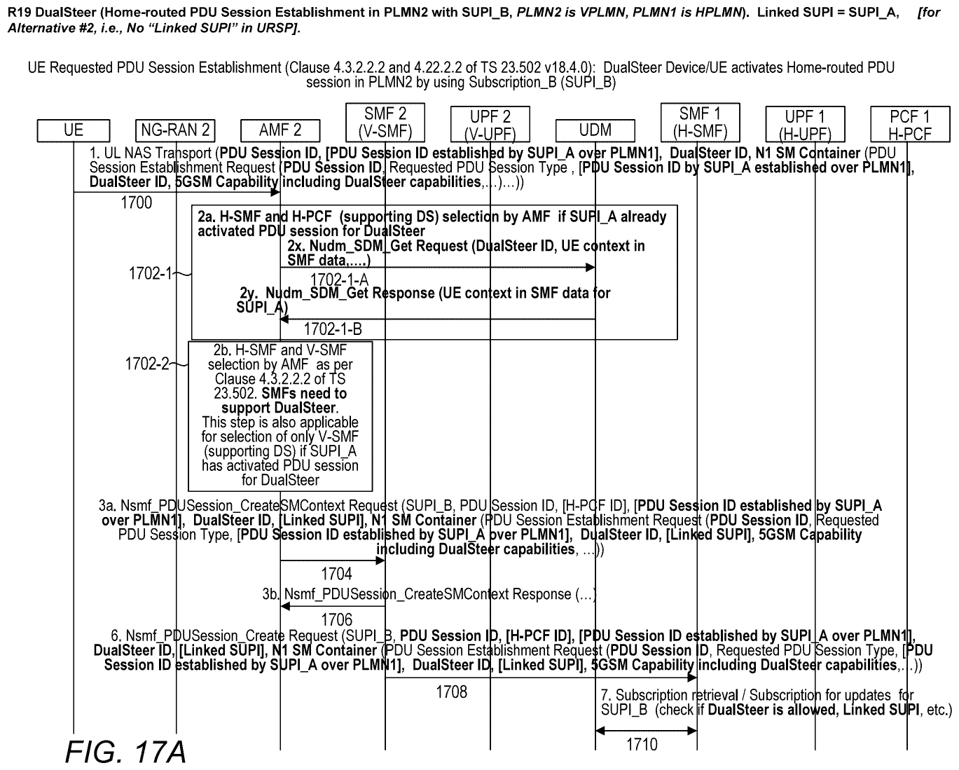

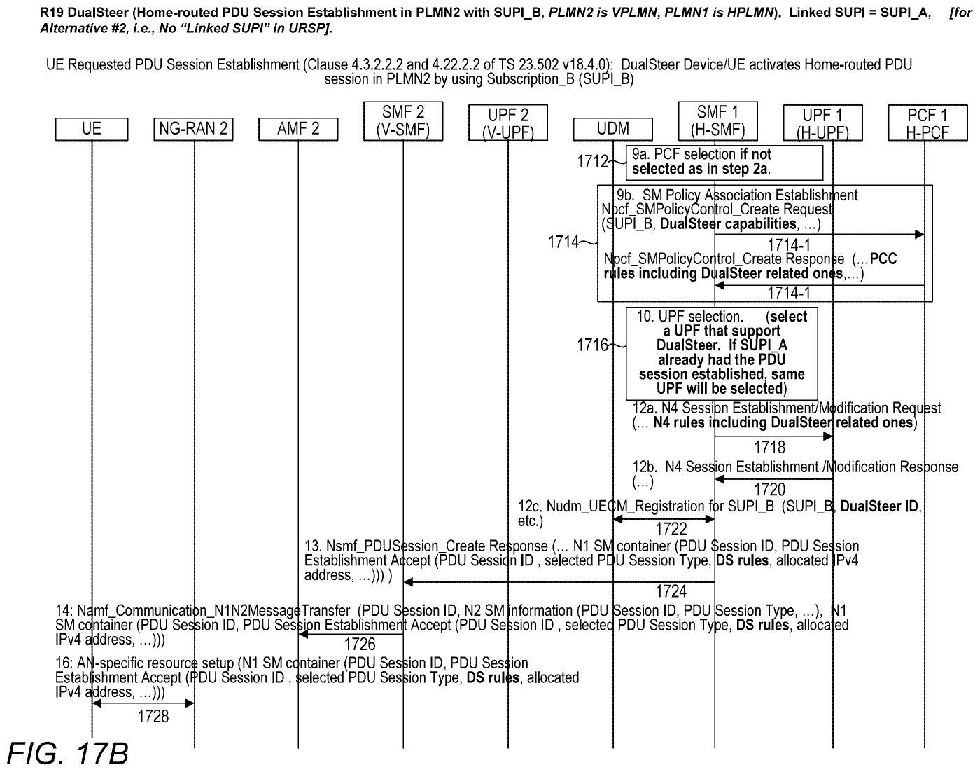

FIGS. 17A-17B are a message sequence diagram illustrating a Multi-Access (MA) PDU session establishment by the UE with PLMN2 using SUPI_B (i.e., subscription B) under alternative #2 above, such that the Linked SUPI_A is not identified in the UL NAS Transport/PDU Session Establishment Request message. In this example, PLMN2 is a VPLMN of the UE. Steps 1700-1720 are substantially similar to the corresponding steps 1500-1520 illustrated in FIGS. 15A-15B, which in turn are substantially similar to the corresponding steps 1300-1320 of FIGS. 13A-13B, and for the sake of brevity will not be repeated herein, except as discussed below. Steps 1724-1728 similarly correspond to steps 1522-1526 of FIGS. 15A-15B, and for the sake of brevity will not be repeated herein.

At step 1700 the Linked SUPI IE is not included in the UL NAS Transport/PDU Session Establishment Request message.

At step 1702-1, if SUPI_A (e.g., the Linked SUPI) has a PDU session already established and the corresponding PDU Session ID is included in the PDU Session ID of the Linked SUPI in UL NAS Transport message, the AMF 2 queries the UDM of the Linked SUPI by using the dualsteer ID to receive the UE context in SMF Data. The AMF matches the received UE context information with the PDU Session ID of the Linked SUPI to identify the H-SMF ID and the PCF ID to be used for the PDU Session.

At step 1704 the Linked SUPI is included if received in successful execution of step 1702-1.

At step 1708 the Linked SUPI is included if received in successful execution of step 1702-1.

At step 1710 the SMF-1 (H-SMF) retrieves the SM subscription data of SUPI_B including the Linked SUPI information associated with the dualsteer ID.

At step 1722 the SMF-1 (H-SMF) registers to the UDM including the dualsteer ID component by using Nudm_UECM_Registration signalling.

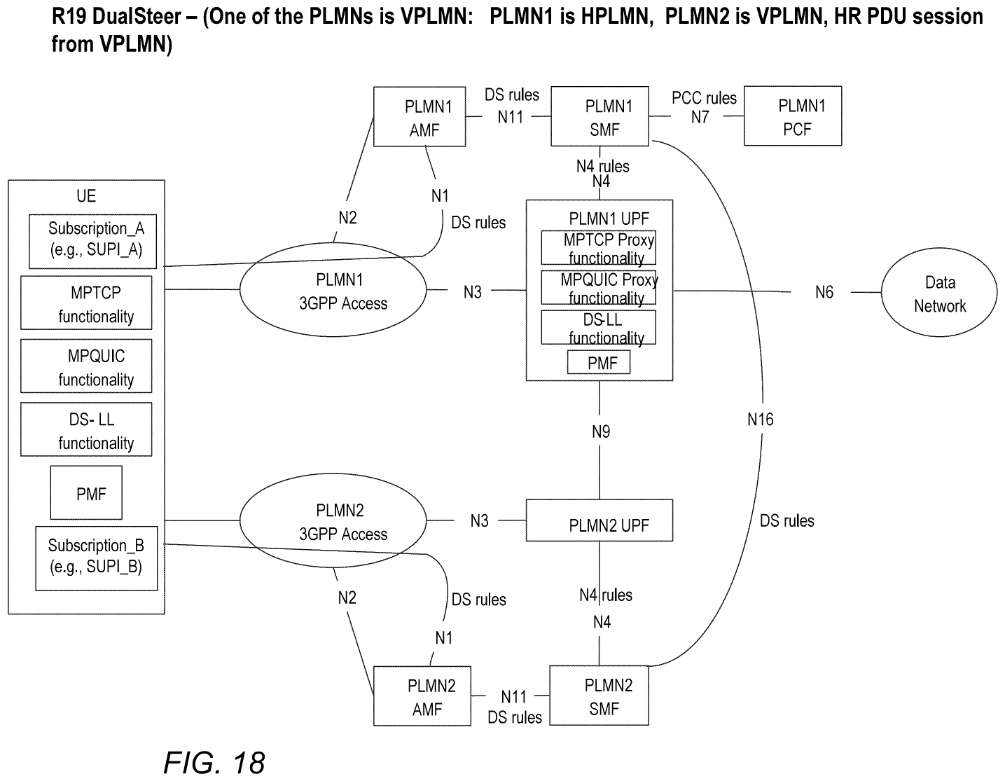

FIG. 18 is a block diagram of a sample DS connectivity model wherein SUPI_A is used to connect to PLMN1 as the HPLMN of the UE and SUPI_B is used to connect to PLMN2 as a VPLMN. It is noted that while illustrated using two AMFs, in other examples the AMFs can be the same AMF. It is further noted that the same SMF is selected for both PDU sessions, in this example, PLMN1 SMF. It is further noted that the same PCF is selected for both PDU sessions.

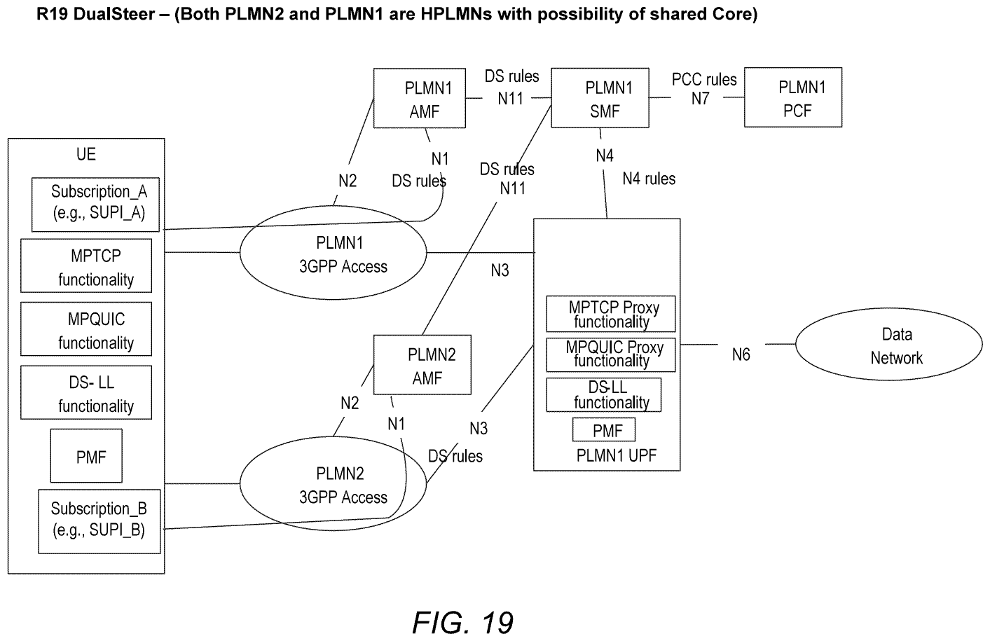

FIG. 19 is a block diagram of a sample DS connectivity model wherein SUPI A is used to connect to PLMN1 as the HPLMN of the UE and SUPI_B is used to connect to PLMN2 as the HPLMN. It is again noted that while illustrated using two AMFs, in other examples the AMFs can be the same AMF. It is further noted that the same SMF is selected for both PDU sessions, the same PCF is selected for both PDU sessions and the same UPF is used for both sessions.

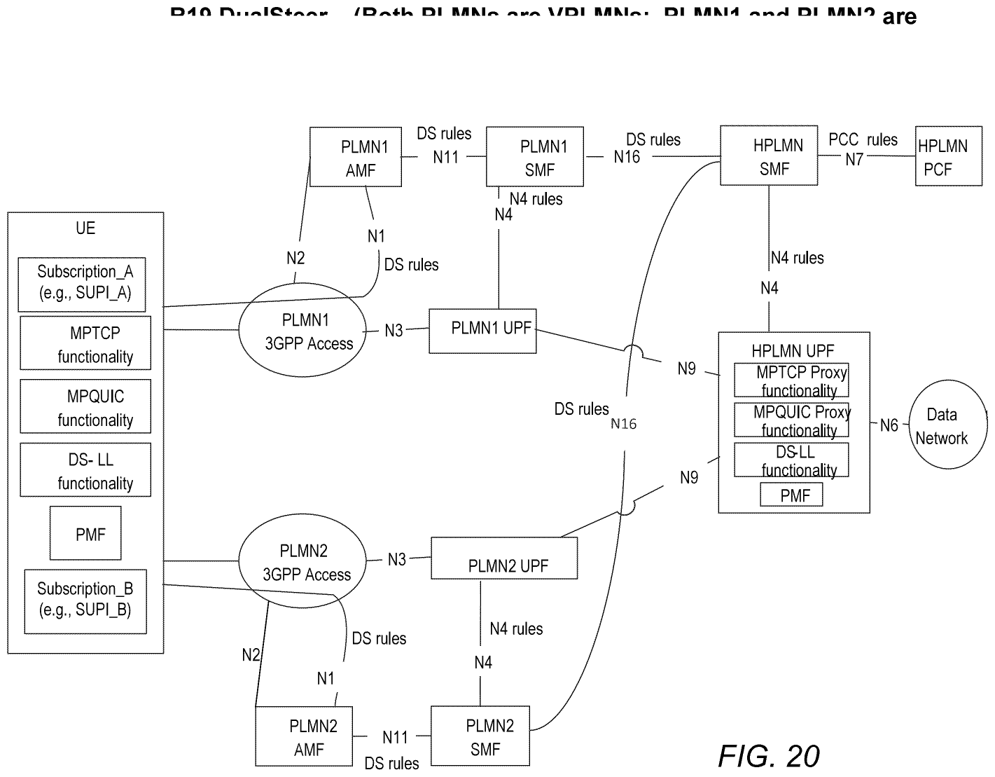

FIG. 20 is a block diagram of a sample DS connectivity model wherein SUPI_A is used to connect to PLMN1 as a VPLMN of the UE and SUPI_B is used to connect to PLMN2 as a VPLMN. It is again noted that the same SMF is selected for both PDU sessions, a HPLMN SMF, the same PCF is selected for both PDU sessions, a HPLMN PCF, and the same UPF is used for both sessions, a HPLMN UPF.

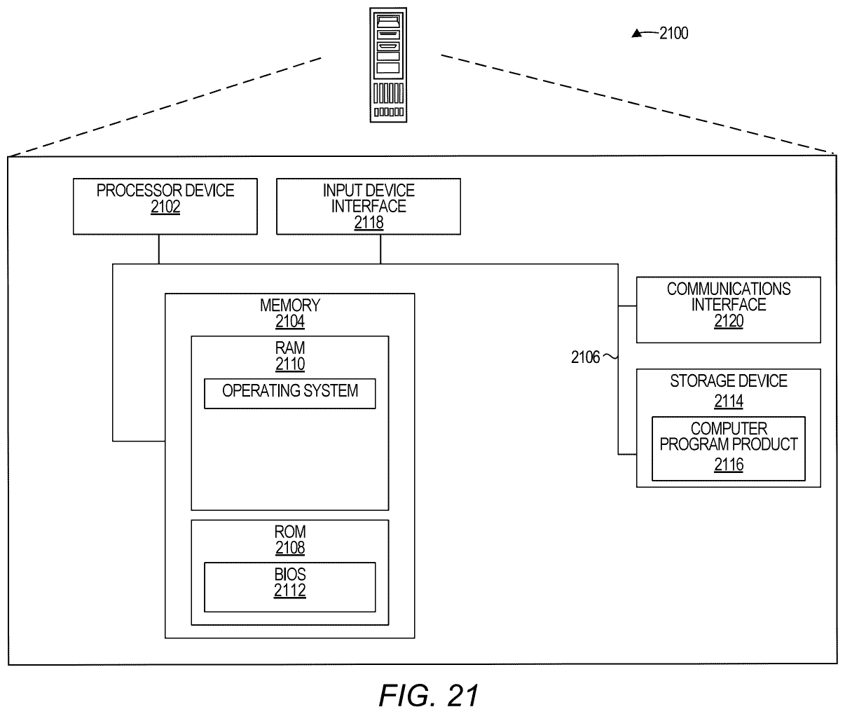

FIG. 21 is a block diagram of a computing device 2100 suitable for implementing any of the various nodes discussed herein, such as, for example, an AMF node, an SMF node, a PCF node, a UPF node, or a UDM node. The computing device 2100 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 2100 includes the processor device 2102, a system memory 2104, and a system bus 2106. The system bus 2106 provides an interface for system components including, but not limited to, the system memory 2104 and the processor device 2102. The processor device 2102 can be any commercially available or proprietary hardware processor device.

The system bus 2106 may be any of several types of bus structures that may further interconnect to a memory bus (with or without a memory controller), a peripheral bus, and/or a local bus using any of a variety of commercially available bus architectures. The system memory 2104 may include non-volatile memory 2108 (e.g., read-only memory (ROM), erasable programmable read-only memory (EPROM), electrically erasable programmable read-only memory (EEPROM), etc.), and volatile memory 2110 (e.g., random-access memory (RAM)). A basic input/output system (BIOS) 2112 may be stored in the non-volatile memory 2108 and can include the basic routines that help to transfer information between elements within the computing device 2100. The volatile memory 2110 may also include a high-speed RAM, such as static RAM, for caching data.

The computing device 2100 may further include or be coupled to a non-transitory computer-readable storage medium such as a storage device 2114, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 2114 and other drives associated with computer-readable media and computer-usable media may provide non-volatile storage of data, data structures, computer-executable instructions, and the like.

A number of modules can be stored in the storage device 2114 and in the volatile memory 2110, including an operating system and one or more program modules suitable for implementing the functionality of the particular AMF node, SMF node, PCF node, UPF node, or UDM node. All or a portion of the examples may be implemented as a computer program product 2116 stored on a transitory or non-transitory computer-usable or computer-readable storage medium, such as the storage device 2114, which includes complex programming instructions, such as complex computer-readable program code, to cause the processor device 2102 to carry out the steps described herein. Thus, the computer-readable program code can comprise software instructions for implementing the functionality of the examples described herein when executed on the processor device 2102.

An operator may also be able to enter one or more configuration commands through a keyboard (not illustrated), a pointing device such as a mouse (not illustrated), or a touch-sensitive surface such as a display device. Such input devices may be connected to the processor device 2102 through an input device interface 2118 that is coupled to the system bus 2106 but can be connected by other interfaces such as a parallel port, an Institute of Electrical and Electronic Engineers (IEEE) 1394 serial port, a Universal Serial Bus (USB) port, an IR interface, and the like. The computing device 2100 may also include one or more communications interfaces 2120, such as Ethernet transceivers, wireless transceivers, coaxial transceivers, fiber transceivers, or the like, suitable for communicating with other nodes and devices as appropriate or desired.

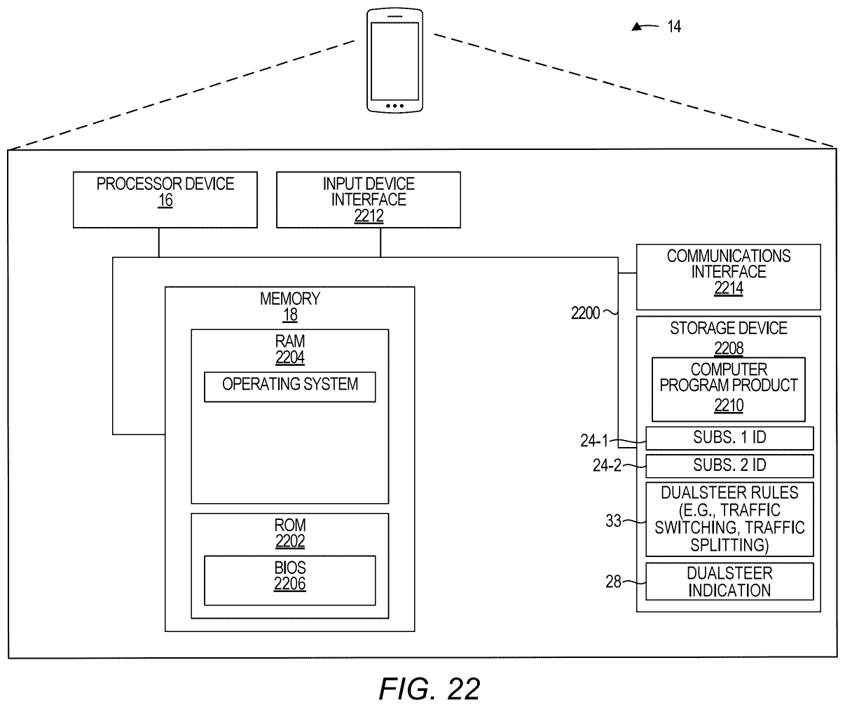

FIG. 22 is a block diagram of the UE 14 suitable for implementing a UE as described herein. The UE 14 may comprise any computing or electronic device capable of including firmware, hardware, and/or executing software instructions to implement the functionality described herein, such as a mobile phone, a computing tablet, an automobile, a smart watch, a computer, computer server, or the like. The UE 14 may include the processor device 16, the system memory 18, and a system bus 2200. The system bus 2200 provides an interface for system components including, but not limited to, the system memory 18 and the processor device 16. The processor device 16 can be any commercially available or proprietary hardware processor device.

The system bus 2200 may be any of several types of bus structures that may further interconnect to a memory bus (with or without a memory controller), a peripheral bus, and/or a local bus using any of a variety of commercially available bus architectures. The system memory 18 may include non-volatile memory 2202 (e.g., read-only memory (ROM), erasable programmable read-only memory (EPROM), electrically erasable programmable read-only memory (EEPROM), etc.), and volatile memory 2204 (e.g., random-access memory (RAM)). A basic input/output system (BIOS) 2206 may be stored in the non-volatile memory 2202 and can include the basic routines that help to transfer information between elements within the UE 14. The volatile memory 2204 may also include a high-speed RAM, such as static RAM, for caching data.

The UE 14 may further include or be coupled to a non-transitory computer-readable storage medium such as a storage device 2208, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 2208 and other drives associated with computer-readable media and computer-usable media may provide non-volatile storage of data, data structures, computer-executable instructions, and the like.

A number of modules can be stored in the storage device 2208 and in the volatile memory 2204, including an operating system and one or more program modules suitable for implementing the functionality as described herein. All or a portion of the examples may be implemented as a computer program product 2210 stored on a transitory or non-transitory computer-usable or computer-readable storage medium, such as the storage device 2208, which includes complex programming instructions, such as complex computer-readable program code, to cause the processor device 16 to carry out the steps described herein. Thus, the computer-readable program code can comprise software instructions for implementing the functionality of the examples described herein when executed on the processor device 16.

A user may also be able to enter one or more configuration commands through a keyboard (not illustrated), a pointing device such as a mouse (not illustrated), or a touch-sensitive surface such as a display device. Such input devices may be connected to the processor device 16 through an input device interface 2212 that is coupled to the system bus 2200 but can be connected by other interfaces such as a parallel port, an Institute of Electrical and Electronic Engineers (IEEE) 1394 serial port, a Universal Serial Bus (USB) port, an IR interface, and the like. The UE 14 may also include one or more communications interfaces 2214, such as Ethernet transceivers, cellular transceivers, wireless transceivers, or the like, suitable for communicating with other nodes and devices as appropriate or desired.

Other computing system designs and configurations may also be suitable to implement the systems and methods described herein. The following examples illustrate various additional implementations in accordance with one or more aspects of the disclosure.

Example 1 is a method, comprising: receiving, by a first mobility node of a first wireless network, a first registration request from a user equipment (UE), the first registration request comprising a request to connect to the first wireless network and comprising a dualsteer indication that the UE is capable of supporting a dualsteer (DS) mode utilizing two different wireless subscriptions; selecting, by the first mobility node based at least in part on the dualsteer indication, a first policy node from a first plurality of policy nodes, the first policy node being operable to support the dualsteer mode; and sending, by the first mobility node to the UE, a first registration accept message indicating network support for the DS mode.

Example 2 is the method of example 1, wherein the first registration request comprises information identifying support for a simultaneous data transfer capability or a non-simultaneous data transfer capability.

Example 3 is the method of example 1, wherein the first wireless network is a 5G network.

Example 4 is the method of example 1, wherein the first registration request is relayed from the UE to the mobility node by a gNB of a radio access network.

Example 5 is the method of example 1, wherein selecting the first policy node from the first plurality of policy nodes further comprises: determining, by the first mobility node, that the first policy node supports the DS mode.

Example 6 is the method of example 1, further comprising: sending, by the first mobility node to the first policy node, information that identifies the UE and an indication that the UE is capable of supporting the DS mode utilizing the two different wireless subscriptions.

Example 7 is the method of example 6, further comprising: sending, by the first mobility node to the first policy node, information identifying support by the UE for the simultaneous data transfer capability or the non-simultaneous data transfer capability.

Example 8 is the method of example 1, further comprising: receiving, by a second mobility node of a second wireless network, a second registration request from the UE, the second registration request comprising a request to connect to the second wireless network and comprising the dualsteer indication that the UE is capable of supporting the DS mode utilizing the two different wireless subscriptions; selecting, by the second mobility node based at least in part on the dualsteer indication, a second policy node from a second plurality of policy nodes, the second policy node being operable to support the dualsteer mode; and sending, by the second mobility node to the UE, a registration accept message indicating network support for the DS mode.

Example 9 is the method of example 8 wherein the first mobility node and the second mobility node are a same mobility node.

Example 10 is the method of example 8 wherein the first policy node and the second policy node are a same policy node.

Example 11 is the method of example 8, wherein the first wireless network and the second wireless network are a same Public Land Mobile Network.

Example 12 is the method of example 8, wherein the second registration request comprises information identifying support for the simultaneous data transfer capability or the non-simultaneous data transfer capability.

Example 13 is the method of example 1, further comprising: receiving, by the first mobility node from the UE, a data services request to establish a first subscription data session via the first wireless network using a first subscription of the two different subscriptions, the data services request comprising a dualsteer identifier (ID) and a second subscription ID that identifies a second subscription of the two different wireless subscriptions.

Example 14 is the method of example 13, wherein the data services request comprises a data session identifier identifying a second subscription data session previously established by the UE using the second subscription, and further comprising: determining, by the first mobility node, based on the dualsteer ID, a data session handler node previously selected to manage the second subscription data session; selecting, by the first mobility node, the data session handler node to manage the first subscription data session; determining, by the first mobility node, based on the second subscription ID, a policy node previously selected for policy management of the second data session; and selecting, by the first mobility node, the policy node for policy management of the first subscription data session.

Example 15 is the method of example 14, further comprising: receiving, by the first mobility node from the data session handler node, dualsteer rules that identify traffic steering rules for the UE; sending, by the mobility node to the UE, a data session establishment accept message that includes the dualsteer rules.

Example 16 is the method of example 13, wherein the data services request omits a data session identifier identifying a second subscription data session previously established by the UE using the second subscription, and further comprising: selecting, by the first mobility node from a plurality of data session handler nodes, a data session handler node that is operable to implement the DS mode; and selecting, by the first mobility node from a plurality of policy nodes, a policy node that is operable to implement the DS mode.

Example 17 is the method of example 1, further comprising: receiving, by the first mobility node from the UE, a data services request to establish a first subscription data session via the first wireless network using a first subscription of the two different subscriptions, the data services request comprising a dualsteer identifier (ID).

Example 18 is the method of example 17, wherein the data services request comprises a data session identifier identifying a second subscription data session previously established by the UE using the second subscription, and further comprising: determining, by the first mobility node, based on the dualsteer ID, a data session handler node previously selected to manage the second subscription data session; selecting, by the first mobility node, the data session handler node to manage the first subscription data session; determining, by the first mobility node, based on the second subscription ID, a policy node previously selected for policy management of the second data session; and selecting, by the first mobility node, the policy node for policy management of the first subscription data session.

Example 19 is the method of example 18, further comprising: receiving, by the first mobility node from the data session handler node, dualsteer rules that identify traffic steering rules for the UE; and sending, by the mobility node to the UE, a data session establishment accept message that includes the dualsteer rules.

Example 20 is the method of example 17, wherein the data services request omits a data session identifier identifying a second subscription data session previously established by the UE using the second subscription, and further comprising: selecting, by the first mobility node from a plurality of data session handler nodes, a data session handler node that is operable to implement the DS mode; and selecting, by the first mobility node from a plurality of policy nodes, a policy node that is operable to implement the DS mode.

Example 21 is a mobility node, comprising: a memory; and a processor device coupled to the memory and operable to: receive a first registration request from a user equipment (UE), the first registration request comprising a request to connect to a wireless network and comprising a dualsteer indication that the UE is capable of supporting a dualsteer (DS) mode utilizing two different wireless subscriptions; select, based at least in part on the dualsteer indication, a first policy node from a first plurality of policy nodes, the first policy node being operable to support the dualsteer mode; and send, to the UE, a first registration accept message indicating network support for the DS mode.

Example 22 is a non-transitory computer-readable storage medium that includes executable instructions operable to cause one or more processor devices of a mobility node to: receive a first registration request from a user equipment (UE), the first registration request comprising a request to connect to a wireless network and comprising a dualsteer indication that the UE is capable of supporting a dualsteer (DS) mode utilizing two different wireless subscriptions; select, based at least in part on the dualsteer indication, a first policy node from a first plurality of policy nodes, the first policy node being operable to support the dualsteer mode; and send, to the UE, a first registration accept message indicating network support for the DS mode.

Example 23 is a method, comprising: receiving, by a data session handler node of a first wireless network from a mobility node of the first wireless network, a request to establish a first subscription data session for a user equipment (UE) having a first wireless subscription and a second wireless subscription, the request comprising a dualsteer (DS) identifier (ID) indicating that the UE is capable of supporting a DS mode utilizing the first wireless subscription and the second wireless subscription and wherein the request is associated with the first wireless subscription; selecting, by the data session handler node, a policy node of a plurality of policy nodes from which to obtain DS rules comprising traffic steering rules associated with traffic steering between the first subscription data session and a second subscription data session; providing, by the data session handler node to the policy node, information that identifies the UE and information that indicates the UE is capable of supporting the DS mode; receiving, by the data session handler node from the policy node, the DS rules comprising traffic steering rules; selecting, by the data session handler node, a user plane function (UPF) node of a plurality of UPF nodes to interface with the UE to forward traffic from the UE to an external network; and providing, by the data session handler node to the mobility node for delivery to the UE, a UPF node identifier identifying the UPF node and the DS rules comprising traffic steering rules.

Example 24 is the method of example 23, wherein the request comprises information indicating that the UE has previously established a second subscription data session for the UE using the second wireless subscription and comprises information identifying a first policy node of the plurality of policy nodes that was selected to obtain DS rules comprising traffic steering rules for the second subscription data session, and wherein selecting, by the data session handler node, the policy node of the plurality of policy nodes comprises selecting, by the data session handler node, the first policy node.

Example 25 is the method of example 23, wherein the request comprises information indicating that the UE has not established a second subscription data session for the UE using the second wireless subscription, and wherein selecting, by the data session handler node, the policy node of the plurality of policy nodes comprises selecting, by the data session handler node, a policy node that supports the DS mode.

Example 26 is the method of example 25, further comprising: determining, by the data session handler node, a home pubic land mobile network (HPLMN) associated with the UE; and wherein selecting, by the data session handler node, the policy node of the plurality of policy nodes comprises selecting, by the, by the data session handler node, a policy node that supports the DS mode and is in the HPLMN.

Example 27 is the method of example 23, wherein the request comprises information indicating that the UE has previously established a second subscription data session for the UE using the second wireless subscription and comprises information identifying a first UPF node of the plurality of UPF nodes that was selected to interface with the UE to forward traffic from the UE to the external network, and wherein selecting, by the data session handler node, the UPF node of the plurality of UPF nodes comprises selecting, by the data session handler node, the first UPF node.

Example 28 is the method of example 27, wherein the request comprises information indicating that the UE has not established a second subscription data session for the UE using the second wireless subscription, and wherein selecting, by the data session handler node, the UPF node of the plurality of UPF nodes comprises selecting, by the data session handler node, a UPF node that supports the DS mode.

Example 29 is the method of example 23, further comprising: obtaining, by the data session handler node, subscription information associated with the first wireless subscription; and determining, by the data session handler node based on the subscription information, that the UE is permitted to utilize the DS mode.

Example 30 is a data session handler node comprising: a memory; and a processor device coupled to the memory and operable to: receive from a mobility node of the first wireless network, a request to establish a first subscription data session for a user equipment (UE) having a first wireless subscription and a second wireless subscription, the request comprising a dualsteer (DS) identifier (ID) indicating that the UE is capable of supporting a DS mode utilizing the first wireless subscription and the second wireless subscription and wherein the request is associated with the first wireless subscription; select, by the data session handler node, a policy node of a plurality of policy nodes from which to obtain DS rules comprising traffic steering rules associated with traffic steering between the first subscription data session and a second subscription data session; provide, by the data session handler node to the policy node, information that identifies the UE and information that indicates the UE is capable of supporting the DS mode; receive, by the data session handler node from the policy node, the DS rules comprising traffic steering rules; select, by the data session handler node, a user plane function (UPF) node of a plurality of UPF nodes to interface with the UE to forward traffic from the UE to an external network; and provide, by the data session handler node to the mobility node for delivery to the UE, a UPF node identifier identifying the UPF node and the DS rules comprising traffic steering rules.

Example 31 is a non-transitory computer-readable storage medium that includes executable instructions operable to cause one or more processor devices of a data session handler node to: receive from a mobility node of the first wireless network, a request to establish a first subscription data session for a user equipment (UE) having a first wireless subscription and a second wireless subscription, the request comprising a dualsteer (DS) identifier (ID) indicating that the UE is capable of supporting a DS mode utilizing the first wireless subscription and the second wireless subscription and wherein the request is associated with the first wireless subscription; select, by the data session handler node, a policy node of a plurality of policy nodes from which to obtain DS rules comprising traffic steering rules associated with traffic steering between the first subscription data session and a second subscription data session; provide, by the data session handler node to the policy node, information that identifies the UE and information that indicates the UE is capable of supporting the DS mode; receive, by the data session handler node from the policy node, the DS rules comprising traffic steering rules; select, by the data session handler node, a user plane function (UPF) node of a plurality of UPF nodes to interface with the UE to forward traffic from the UE to an external network; and provide, by the data session handler node to the mobility node for delivery to the UE, a UPF node identifier identifying the UPF node and the DS rules comprising traffic steering rules.

Individuals will recognize improvements and modifications to the preferred examples of the disclosure. All such improvements and modifications are considered within the scope of the concepts disclosed herein and the claims that follow.

What is claimed is:

1. A method, comprising:
sending, by a wireless user equipment (UE), to a first wireless network, a first registration request, the first registration request comprising a request to connect to the first wireless network and a first subscription identifier (ID) identifying a first wireless subscription and a dualsteer indication that the UE is capable of supporting a dualsteer (DS) mode utilizing two different wireless subscriptions, the first wireless subscription being one of the two different wireless subscriptions; and
receiving, by the UE from the first wireless network, a first registration accept message indicating network support for the DS mode.

2. The method of claim 1, wherein the first wireless network is a 5G network or a 6G network.

3. The method of claim 1, wherein the first registration request comprises information identifying support for a simultaneous data transfer capability or a non-simultaneous data transfer capability.

4. The method of claim 1, wherein sending the first registration request to the first wireless network comprises sending the first registration request to a first mobility node of the first wireless network.

5. The method of claim 1, further comprising:
receiving, by the UE from the first wireless network, information comprising a dualsteer ID comprising an identifier associated with a second wireless subscription.

6. The method of claim 5, wherein the information comprises a policy data structure comprising the dualsteer ID and one or more of network slice selection instructions identifying a set of network slices the UE is permitted to use, one or more traffic steering policies that identify specific network paths for the UE to use, and a roaming policy identifying one or more wireless networks to which the UE is permitted to roam.

7. The method of claim 5, further comprising:
sending, by the UE, to a second wireless network, a second registration request, the second registration request comprising a request to connect to the second wireless network and a second subscription ID identifying the second wireless subscription and also comprising a dualsteer indication that the UE is capable of supporting the DS mode utilizing the two different wireless subscriptions, the second wireless subscription being another of the two different wireless subscriptions; and
receiving, by the UE from the second wireless network, a second registration accept message indicating network support for the DS mode.

8. The method of claim 7, further comprising:
sending, by the UE, to the first wireless network, a data services request to establish a first subscription data session via the first wireless network, the data services request comprising the dualsteer ID and a first subscription data session ID.

9. The method of claim 8, wherein the first registration accept message further comprises information that identifies the second wireless subscription of the two different wireless subscriptions, and wherein the data services request to establish the first subscription data session comprises the second subscription ID.

10. The method of claim 8, further comprising:
receiving, by the UE from the first wireless network, a data session establishment accept message comprising the first subscription data session ID and dualsteer rules related to traffic steering between the first subscription data session and a second subscription data session.

11. The method of claim 10, further comprising:
sending, by the UE, to the second wireless network, a data services request to establish a second subscription data session via the second wireless network, the data services request to establish the second subscription data session comprising the dualsteer ID, the first subscription data session ID, and a second subscription data session ID.

12. The method of claim 11, further comprising:
receiving, by the UE from the second wireless network, a data session establishment accept message comprising the second subscription data session ID and the dualsteer rules related to traffic steering between the first subscription data session and the second subscription data session.

13. The method of claim 7, wherein the first wireless network and the second wireless network are a same Public Land Mobile Network (PLMN).

14. The method of claim 7, wherein the first wireless network comprises a Home PLMN (HPLMN) and the second wireless network comprises a Visited Public Land Mobile Network (VPLMN).

15. The method of claim 7, wherein the first wireless network comprises a HPLMN and the second wireless network comprises a HPLMN.

16. The method of claim 7, further comprising:
receiving, by the UE from the Internet via the first wireless network, a first stream of data; and
concurrently receiving, by the UE from the Internet via the second wireless network, a second stream of data.

17. The method of claim 7, wherein the first wireless network is a 5G wireless network and the second wireless network is a 4G wireless network.

18. A wireless user equipment (UE), comprising:
a memory; and
a processor device coupled to the memory and operable to:
send, to a first wireless network, a first registration request, the first registration request comprising a request to connect to the first wireless network and a first subscription identifier (ID) identifying a first wireless subscription and a dualsteer indication that the UE is capable of supporting a dualsteer (DS) mode utilizing two different wireless subscriptions, the first wireless subscription being one of the two different wireless subscriptions; and
receive, from the first wireless network, a first registration accept message indicating network support for the DS mode.

19. A non-transitory computer-readable storage medium that includes executable instructions operable to cause one or more processor devices of a wireless user equipment (UE) to:
send, to a first wireless network, a first registration request, the first registration request comprising a request to connect to the first wireless network and a first subscription identifier (ID) identifying a first wireless subscription and a dualsteer indication that the UE is capable of supporting a dualsteer (DS) mode utilizing two different wireless subscriptions, the first wireless subscription being one of the two different wireless subscriptions; and
receive, from the first wireless network, a first registration accept message indicating network support for the DS mode.

20. A method, comprising:
receiving, by a mobility node of a wireless network, a registration request from a user equipment (UE), the registration request comprising a request to connect to a wireless network and comprising a dualsteer indication that the UE is capable of supporting a dualsteer (DS) mode utilizing two different wireless subscriptions;
selecting, by the mobility node based at least in part on the dualsteer indication, a policy node from a plurality of policy nodes, the policy node being operable to support the DS mode; and
sending, by the mobility node to the UE, a registration accept message indicating network support for the DS mode.

21. A method, comprising:
receiving, by a data session handler node of a wireless network from a mobility node of the wireless network, a request to establish a subscription data session for a user equipment (UE) having a first wireless subscription and a second wireless subscription, the request comprising a dualsteer indication that the UE is capable of supporting a DS mode utilizing the first wireless subscription and the second wireless subscription and wherein the request is associated with the first wireless subscription;
providing, by the data session handler node to a policy node, information that identifies the UE and information that indicates the UE is capable of supporting the DS mode;
receiving, by the data session handler node from the policy node, DS rules comprising traffic steering rules;
selecting, by the data session handler node, a data traffic handling node of a plurality of data traffic handling nodes to interface with the UE to forward traffic from the UE to an external network; and
providing, by the data session handler node to the mobility node for delivery to the UE, a data traffic handling node identifier identifying the data traffic handling node and the DS rules comprising the traffic steering rules.
